(19) United States
(12) Patent Application Publication
(10) Pub. No.: US 2022/0040021 A1
(43) Pub. Date: Feb. 10, 2022

(54) SPINAL DEFORMITY CORRECTION AND FUSION SURGERY SUPPORTING DEVICE

(71) Applicant: MIZUHO CORPORATION, Tokyo (JP)

(72) Inventor: Sohei EBARA, Fujisawa-shi (JP)

(73) Assignee: MIZUHO CORPORATION, Tokyo (JP)

(21) Appl. No.: 17/280,534

(22) PCT Filed: Sep. 27, 2019
(86) PCT No.: PCT/JP2019/038256

§ 371 Date: Mar. 26, 2021

(30) Foreign Application Priority Data
Sep. 27, 2018 (JP) 2018-181791

(51) Int. Cl. A61G 13/00; A61G 13/12

(52) U.S. Cl. CPC A61G 13/0054; A61G 13/1295; A61G 13/129; A61G 2210/50; A61G 13/123; A61G 13/121; A61G 13/122

(57) ABSTRACT

A spinal deformity correction and fusion surgery supporting device is capable of simplifying the operative procedures of a spinal deformity correction and fusion surgery by an operator to reduce the operative time and lessen the burden on the patient and achieving a more effective correction rate by the spinal deformity correction and fusion surgery. In this supporting device, the waist and the vicinity thereof are pressed from both sides in the left-right direction by a pair of waist pressing bodies, and the chest and the vicinity thereof are pressed from both sides in the left-right direction by a pair of chest pressing body to establish a trunk balance. In this state, the pair of chest pressing bodies and the pair of waist pressing bodies are moved away from each other to apply a tensile load to spinal deformity and a state in which the spinal deformity is corrected so as to approach a correction rate by the spinal deformity correction and fusion surgery can be maintained. As a result, a more effective correction rate is achieved by spinal deformity correction and fusion surgery while simplifying the operative procedures of spinal deformity correction and fusion surgery, shortening the operative time, and lessening the burden on the patient.

### TECHNICAL FIELD

The present invention relates to a spinal deformity correction and fusion surgery supporting device (a supporting device for correction and fusion surgery for spinal deformity), the supporting device enabling to correct spinal deformities of a patient at the maximum and maintain the corrected state. The supporting device thereby facilitates spinal deformity correction and fusion surgery (operative treatment) during or immediately before the surgery such as scoliosis surgery for the patient under general anesthesia, who is placed on an operating table in an operating room and undergoes masking or endotracheal intubation.

### BACKGROUND ART

Generally, in the treatment of spinal deformities such as scoliosis, “orthotic treatment” or “surgical therapy” is applied. For example, when the curve of scoliosis at the initial stage is mild (that is, the Cobb angle is approximately 25 degrees) and the progress of the curve is predictable, “orthotic treatment” may be selected. On the other hand, when the curve of scoliosis, that is, the Cobb angle is large and the curve of spinal deformity progresses and worsens, “surgical therapy” is a common option. “Posterior correction and fusion surgery” or “anterior correction and fusion surgery” is applied to “surgical therapy,” which is categorized as surgical spinal deformity correction and fusion surgery.

Specifically, “posterior correction and fusion surgery” is a technique in which: a patient who is under general anesthesia and who has undergone masking or endotracheal intubation is positioned on an operating table in a prone position; an operative wound or a minimally invasive and percutaneous surgical wound is created in the middle of the back of the patient; and the elements behind the spine are unfolded. Subsequently, as illustrated in FIG. 18, screws 210 are screwed and fixed from the back of the spine toward a plurality of vertebral bodies via pedicles, hook members 220 are hooked on a plurality of transverse processes and the like of the spine, and rods 230 are attached to top open grooves of the screws 210 and the hook members 220. In this way, the spinal deformity is corrected three-dimensionally and fused in the corrected state. On the other hand, “anterior correction and fusion surgery” is a technique in which: a patient who is under general anesthesia and who has undergone masking or endotracheal intubation is positioned on an operating table in a lateral recumbent position; an operative wound is created on a lateral side of the patient, or approximately two small incisions are created under the armpit in a minimally invasive manner; and a plurality of vertebral bodies that need correction, which are elements in front of the spine, are unfolded. Subsequently (by using endoscopic supports depending on the situation), screws are screwed and fixed into the unfolded vertebral bodies, and rods are attached to top open grooves or side open grooves of the screws. In this way, the spinal deformity is corrected three-dimensionally and fused in the corrected state (see, for example, Patent Literature 1).

### CITATION LIST

### Patent Literature

[PTL 1] JP2005169064A

### SUMMARY OF INVENTION

### Technical Problem

In “posterior correction and fusion surgery” and “anterior correction and fusion surgery” described above, for three-dimensionally correcting spinal deformity including twisting, an operation of attaching rods to a number of screws and each hook member, an operation of applying a compressive load or a tensile load to each screw and each hook member in a cranio-caudal direction, and an operation of rotating the rod are required as the operative procedures. In these spinal deformity correction and fusion surgery techniques, the more severe the spinal deformity, that is, the larger the Cobb angle, the more difficult and complex becomes the operative procedure (surgical operation). As a result, it may be difficult to achieve an effective correction rate by implants (materials implanted in the body) such as rods, screws, and hook members. Particularly, for seriously ill patients, since the operative procedure is very difficult and complex, there is a concern that the operative time is long and the burden on the patient will increase.

The present invention has been made in view of the above problems, and an object thereof is to provide a spinal deformity correction and fusion surgery supporting device capable of simplifying the operative procedures of spinal deformity correction and fusion surgery for treating spinal deformity by an operator (surgeon), shortening the operative time, lessening the burden on the patient, and achieving a more effective correction rate by the surgery (using implants).

### Means for Solving Problems

### (Aspects of the Invention)

Each aspect of invention shown below exemplifies the configurations of the present invention. In order to facilitate understanding of the various configurations of the present invention, explanation is itemized. Each item does not limit the technical scope of the present invention, and while taking into consideration of the best mode for carrying out the invention, components in each item may be replaced or deleted. Moreover, components may be added with another components. Those should be also regarded as the technical scope of the present invention.

(1) A spinal deformity correction and fusion surgery supporting device, which is placed on an operating table in an operating room, wherein: the supporting device is structured to: 1) correct a spinal deformity of a patient and to hold the patient in the corrected state so as to facilitate spinal deformity correction and fusion surgery; 2) apply to the spinal deformity of the patient under general anesthesia who wears a mask or undergoes endotracheal intubation; and 3) apply immediately before or during the surgery, the supporting device comprising: a pair of chest pressing bodies each of which is structured to be shiftable so as to draw near to and separate from each other in a crosswise direction orthogonal to a cranio-caudal direction of the patient, the chest pressing bodies being structured to be fixable in an arbitrary position; a pair of waist pressing bodies each of which is structured to be shiftable so as to draw near to and separate from each other in a crosswise direction orthogonal to a cranio-caudal direction of the patient, the waist pressing bodies being structured to be fixable in an arbitrary position; and a fixation device that is structured in that the pair of chest pressing bodies and the pair of waist pressing bodies are shiftable so as to draw near to and separate from each other in a cranio-caudal direction of the patient, the fixation device being structured to fix the chest pressing bodies and the waist pressing bodies in an arbitrary position, and wherein the pair of waist pressing bodies are structured to press a waist portion and the surrounding area of the patient from both the left and right sides, and the pair of chest pressing bodies are structured to press a chest portion and the surrounding area of the patient from both the left and right sides, and while keeping the tightened state, the pair of chest pressing bodies and the pair of waist pressing bodies are structured to separate from each other so as to apply a tensile load relative to the deformed spine of the patient in a cranio-caudal direction, and the supporting device is structured to correct the spine of the patient so as to approach to obtain a correction rate achievable by the surgery, the supporting device enabling the patient to be held in the corrected state. (1) corresponds to claim 1.

The spinal deformity correction and fusion surgery supporting device described in (1) of the above is used by placing it on the operating table in the operating room and applied when conducting spinal deformity correction and fusion surgery relative to the spinal deformity of the patient under general anesthesia who wears a mask or undergoes endotracheal intubation. The supporting device is applied to the spinal deformity of the patient in advance of the surgery (using an implant technique) so as to obtain a correction rate as near to the correction rate achievable by the surgery as possible. The supporting device then enables the patient to be held while keeping the correction rate.

Specifically, the spinal deformity correction and fusion surgery supporting device is placed on the operating table in the operating room. The patient under general anesthesia, who wears a mask or undergoes endotracheal intubation, is then placed on the supporting device in a prone position. Next, the pair of waist pressing bodies are shifted so as to draw near to each other for pressing the waist portion and the surrounding area of the patient from both the left and right sides. Further, the pair of chest pressing bodies are shifted so as to draw near to each other for pressing the chest portion and the surrounding area of the patient from both the left and right sides. The waist pressing bodies and the chest pressing bodies are then kept in the tightened state. As a result, the patient's trunk is balanced in a crosswise direction, so the position of the whole spine in the crosswise direction is corrected. The supporting device holds the patient in a corrected state. Subsequently, operators pull both the upper limbs and the lower limbs of the patient in a cranio-caudal direction. While doing so, the operators shift the pair of chest pressing bodies and the pair of waist pressing bodies so as to separate them from each other. Especially, by pulling the chest portion as well as the surrounding area and the waist portion as well as the surrounding area in a cranio-caudal direction, a tensile load is applied to the spinal deformity. A fixation device then holds the patient in the above condition. As a result, the supporting device can correct spinal deformities such as a scoliosis deformity, a kyphosis deformity, a lordosis deformity or a rotatory deformity. The supporting device also enables the patient to be held in the corrected state.

By conducting supporting device, the spinal deformation of the patient is corrected and kept in the corrected state in advance of the surgery in such a manner as to obtain a correction rate as near to the correction rate achievable by the surgery as possible. In this prior corrected condition, operators conduct the surgery. That is, this supporting device has functions for supporting or assisting the surgery, which uses an implant technique.

It would be most preferable that the effective correction rate after the surgery is approximately 100%. However, the surgery aims to correct the deformed spine, possibly to at least 50% (½) or more (although depending on the stiffness of a spine curve) relative to Cobb angles of spinal deformation shown in an X-ray photograph (see FIG. 16 (b)). The X-ray photograph shows the condition where, in advance of the surgery, both the upper limbs and the lower limbs of the patient are pulled so as to stretch the patient's trunk in a cranio-caudal direction.

(2) As to the spinal deformity correction and fusion surgery supporting device described in (1) of the above, each structural member of the supporting device has materials, which are X-ray permeable. (2) corresponds to claim 2.

In the supporting device of (2), at each of the appropriate times, which includes the time during the surgery, by using X-ray fluoroscopic photographing apparatuses or CT scanners (for example, multi-axis CT image formers), it is possible to confirm the correction condition of the deformed spine, and the fitting conditions of implants such as the condition of screws or the fitting condition of hook members.

(3) As to the spinal deformity correction and fusion surgery supporting device described in (1) or (2) of the above, the supporting device further includes a coupler in which to detachably couple the supporting device with operating tables. (3) corresponds to claim 3.

In the supporting device of (3), while conducting the spinal deformity correction and fusion surgery, it is possible to inhibit the supporting device from being shifted relative to the operating table. It thus enables to improve the correction rate and correction effects obtained by the surgery as well as safety needed for the surgery. Moreover, during the surgery, it is possible to make the supporting device follow along with movements of the operating table.

(4) As to the spinal deformity correction and fusion surgery supporting device described in any of (1) to (3) of the above, each of the pair of chest pressing bodies is detachably mounted to a chest support that extends in a crosswise direction orthogonal to the cranio-caudal direction of the patient, and each of the pair of waist pressing bodies is detachably mounted to a waist support that extends in a crosswise direction orthogonal to the cranio-caudal direction of the patient. (4) corresponds to claim 4.

In the supporting device of (4), as necessary, the pair of the chest pressing bodies may be detached from the chest support. As the same, the pair of the west pressing bodies may be detached from the waist support. As the result, a patient can be easily relocated onto the supporting device.

(5) As to the spinal deformity correction and fusion surgery supporting device described in any of (1) to (4) of the above, the supporting device is specialized for posterior correction and fusion surgery in the spinal deformity correction and fusion surgery. (5) corresponds to claim 5.

In the supporting device of (5), when conducting the surgery for spinal deformation, it is especially effective for the “posterior correction and fusion surgery” as said above.

(6) As to the spinal deformity correction and fusion surgery supporting device described in any of (1) to (5) of the above, the supporting device includes: a chest pressing body fixation device that enables the chest pressing bodies to fix in an arbitrary position or be released for shift, through operation of a slide switch by an operator; a waist pressing body fixation device that enables the waist pressing bodies to fix in an arbitrary position or be released for being shiftable, along with handling of a slide switch by the operator; a chest pressing unit fixation device that enables a chest pressing unit, which includes the pair of chest pressing bodies, to fix in an arbitrary position in a cranio-caudal direction of the patient or be released for shift, through operation of a slide switch by the operator; and a waist pressing unit fixation device that enables a waist pressing unit, which includes the pair of waist pressing bodies, to fix in an arbitrary position in a cranio-caudal direction of the patient or be released for shift, through operation of a slide switch by the operator. (6) corresponds to claim 6.

In the supporting device of (6), operators can easily perform correction for spinal deformities by using the supporting device. Moreover, even in the middle of the surgery, the operators can easily apply a tensile load to the spinal deformities of patients from the outside (meaning the exterior of the patients). With this, the operators can not only more advancingly correct the spine deformities but also more effectively balance the patients' trunks, while pressing the chest portion and the surrounding area as well as the waist portion and the surrounding area of the patients from both the left and right sides of them.

(7) As to the spinal deformity correction and fusion surgery supporting device described in any of (1) to (6) of the above, the supporting device further includes: a head support that is structured to support the head of the patient at a prescribed height and couple with the pair of chest pressing bodies, wherein the head support includes: a head supporting section with a concaved section, the concaved section being structured to support and enfold the face of the patient; and a cushion portion arranged in the concaved section of the head supporting section. (7) corresponds to claim 7.

In the supporting device of (7), during the surgery, the head support can easily support and protect the head of a patient. Moreover, since the head support is provided with the cushion portion, during the surgery, burdens to the face of the patient can be minimized, thereby enabling the patient to be positioned in a stable manner.

(8) As to the spinal deformity correction and fusion surgery supporting device described in (7) of the above, the head support includes an opening at each place where the patient's eyes and mouth are positioned. (8) corresponds to claim 8.

In the supporting device of (8), since the head support has openings at places where the patient's eyes are positioned, it is possible to reduce pressure on the patient's eyeballs, etc. during the surgery. Moreover, the head support has an opening at place where the patient's mouth is positioned, it can help an endotracheal intubation tube easily extending from the oral region of the patient, through the opening of the head support.

(9) As to the spinal deformity correction and fusion surgery supporting device described in (7) or (8) of the above, a head support unit including the head support is structured to couple with the chest support by means of an intermediate support. Moreover, the intermediate support is structured to be arranged at a predetermined height position from the chest support.

In the supporting device of (9), the intermediate support holds the head-side front surface of the patient's chest at a predetermined height. Thus, when placing the patient on the supporting device, it is possible to position the patient's head to be lower than his or her chest.

(10) As to the spinal deformity correction and fusion surgery supporting device described in (9) of the above, the side on the head support unit of the intermediate support has a concave runoff.

In the supporting device of (10), after correcting the patient's spine while operating the device, the patient's body would tend to shrink in a cranio-caudal direction. In this condition, even the head of the patient is shifted toward the caudal side along with the head support, this concave runoff helps the head support to shift toward the caudal side of the patient.

(11) As to the spinal deformity correction and fusion surgery supporting device described in any of (1) to (10) of the above, the pair of chest pressing bodies, the pair of waist pressing bodies, the chest pressing unit including the pair of chest pressing bodies, and the chest pressing unit including the pair of chest pressing bodies are each structured to shift with driving force by a drive motor.

In the supporting device of (11), operators' loads are reduced at the time of the operation of the supporting device.

### Advantageous Effects of Invention

According to the spinal deformity correction and fusion surgery supporting device of the present invention, it is possible to perform spinal deformity correction and fusion surgery by an operator in a state that the spinal deformity is corrected and maintained so as to approach to obtain a correction rate achievable by the surgery. In this way, when an operator performs the surgery, it is possible to simplify the operative procedures, and as a result, shorten the operative time, and lessen the burden on the patient. This consequently enables to achieve a more effective correction rate in surgery (using implants).

### BRIEF DESCRIPTION OF DRAWINGS

FIG. 1 is a perspective view illustrating a state in which a patient is placed in a prone position on a spinal deformity correction and fusion surgery supporting device according to an embodiment of the present invention.

FIG. 2 is a perspective view illustrating a state in which the spinal deformity correction and fusion surgery supporting device is connected to an operating table.

FIG. 3 is a perspective view of the spinal deformity correction and fusion surgery supporting device in which various pads are removed.

FIG. 4 is a perspective view illustrating a base unit of the spinal deformity correction and fusion surgery supporting device.

FIG. 5 is a perspective view of the spinal deformity correction and fusion surgery supporting device, illustrating a state in which a chest presser fixing means and a non-slip projection are integrally connected to a chest pressing body.

FIG. 6 is a perspective view of the spinal deformity correction and fusion surgery supporting device, illustrating a state in which a chest presser fixing means and a non-slip projection are assembled to a chest pressing body.

FIG. 7 is an exploded perspective view of a chest presser fixing means of the spinal deformity correction and fusion surgery supporting device.

FIG. 8 is a perspective view of a chest pressing support of the spinal deformity correction and fusion surgery supporting device.

FIG. 9 is a perspective view of a chest pressing unit fixing means of the spinal deformity correction and fusion surgery supporting device.

FIG. 10 is an exploded perspective view of a chest pressing unit fixing means of the spinal deformity correction and fusion surgery supporting device.

FIG. 11 is a perspective view of the spinal deformity correction and fusion surgery supporting device in which a head support unit and a chest pressing support of a chest pressing unit are integrally connected.

FIG. 12 is a perspective view of the spinal deformity correction and fusion surgery supporting device in which a waist presser fixing means and a non-slip projection are integrally connected to a waist pressing body.

FIG. 13 is a perspective view illustrating a waist support of the spinal deformity correction and fusion surgery supporting device.

FIG. 14 is a diagram for explaining the operation of the spinal deformity correction and fusion surgery supporting device.

FIG. 15 is a side view of a state in which a plurality of cushion members are stacked on a chest-front support pad and an waist-front support pad of the spinal deformity correction and fusion surgery supporting device, and a patient with scoliosis, kyphoscoliosis, or kyphosis is positioned thereon in a prone position, and kyphosis is corrected.

FIG. 16(a) is a frontal X-ray photograph of a scoliosis patient in a standing position before surgery, and FIG. 16(b) is a frontal X-ray photograph in a state in which the patient is pulled in a cranio-caudal direction before surgery.

FIG. 17(a) is an X-ray photograph in a prone position in a state in which the chest and the vicinity thereof and the waist and the vicinity thereof, of the patient illustrated in FIG. 16 are pressed from both sides in the left-right direction by the spinal deformity correction and fusion surgery supporting device, FIG. 17(b) is an X-ray photograph in a prone position in a state in which the patient is pulled in the cranio-caudal direction from the state of FIG. 17(a), and FIG. 17(c) is an X-ray photograph in a prone position after “posterior correction and fusion surgery” which is surgical spinal deformity correction and fusion surgery is performed.

FIG. 18 is a view illustrating an example of correction and fusion by a plurality of implants after “posterior correction and fusion surgery” which is surgical spinal deformity correction and fusion surgery for spinal deformity is performed.

### DESCRIPTION OF EMBODIMENTS

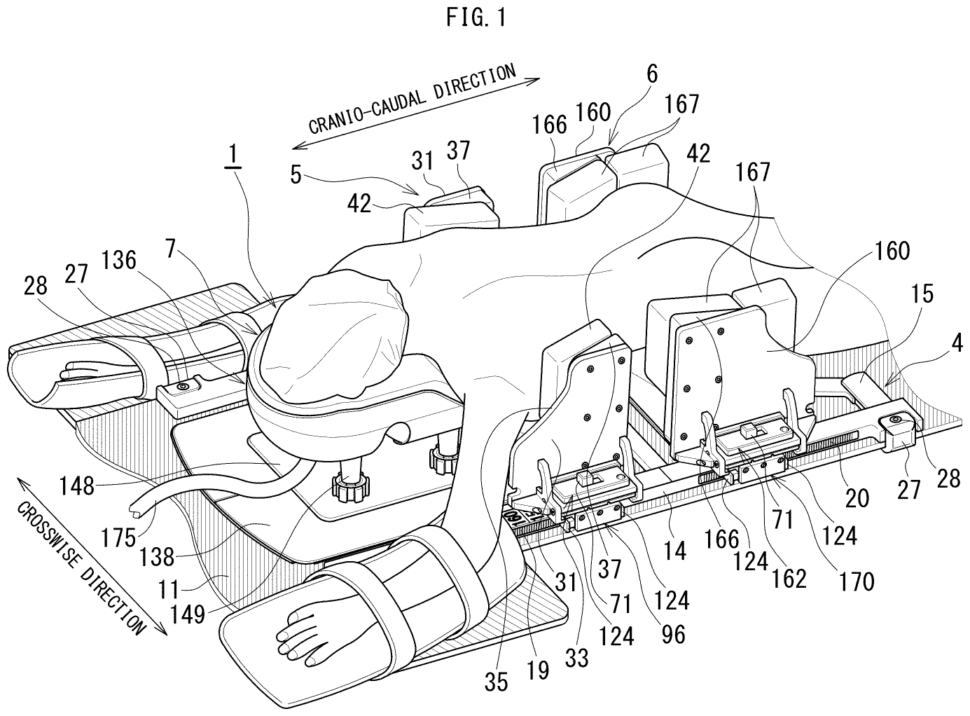

Hereinafter, an embodiment of the present invention will be described in detail with reference to FIGS. 1 to 18.

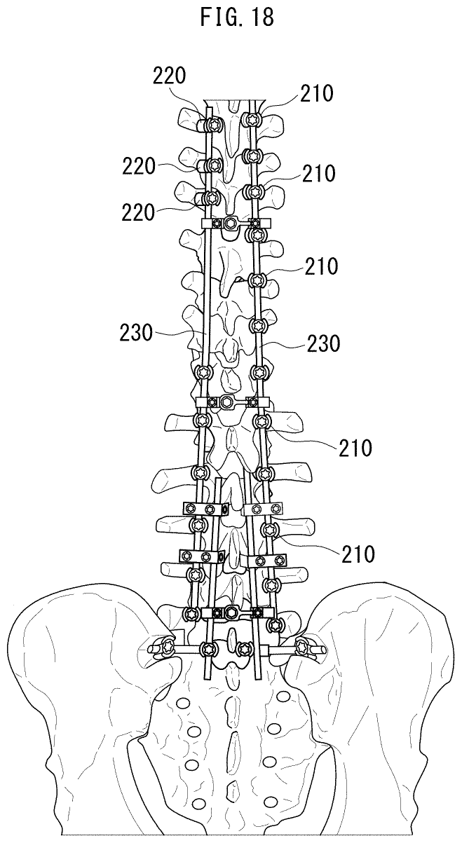

A spinal deformity correction and fusion surgery supporting device 1 according to an embodiment of the present invention corrects spinal deformities such as scoliosis or kyphosis (lordosis) and enables a patient's spine to be kept in the corrected state. The supporting device 1 is used when conducting surgical spinal deformity correction and fusion surgery (that is, the “posterior correction and fusion surgery”) for spinal deformities (see FIG. 18). In other words, the supporting device 1 is exclusively used for “posterior correction and fusion surgery.” The supporting device 1 corrects spinal deformities in advance of conducting “posterior correction and fusion surgery,” thereby approaching to obtain a correction rate achievable by the surgery at a pre-operation stage immediately before the surgery. “Posterior correction and fusion surgery” is surgical spinal deformity correction and fusion surgery by an operator (surgeon), which enables the patient's spine to be kept in the corrected state in the surgery. Moreover, the supporting device 1 may be operated during the surgery (operation to press the patient's deformed spine harder) so that the patient's spinal deformities are more advancingly corrected. That is, the supporting device 1 corrects spinal deformities, maintains the spinal deformities in the corrected state, and facilitates the surgery during or immediately before conducting the surgery for spinal deformities such as scoliosis of a patient who is under general anesthesia and who has undergone masking or endotracheal intubation.

Hereinafter, the supporting device 1 according to the embodiment of the present invention will be described in detail with reference to FIGS. 1 to 18.

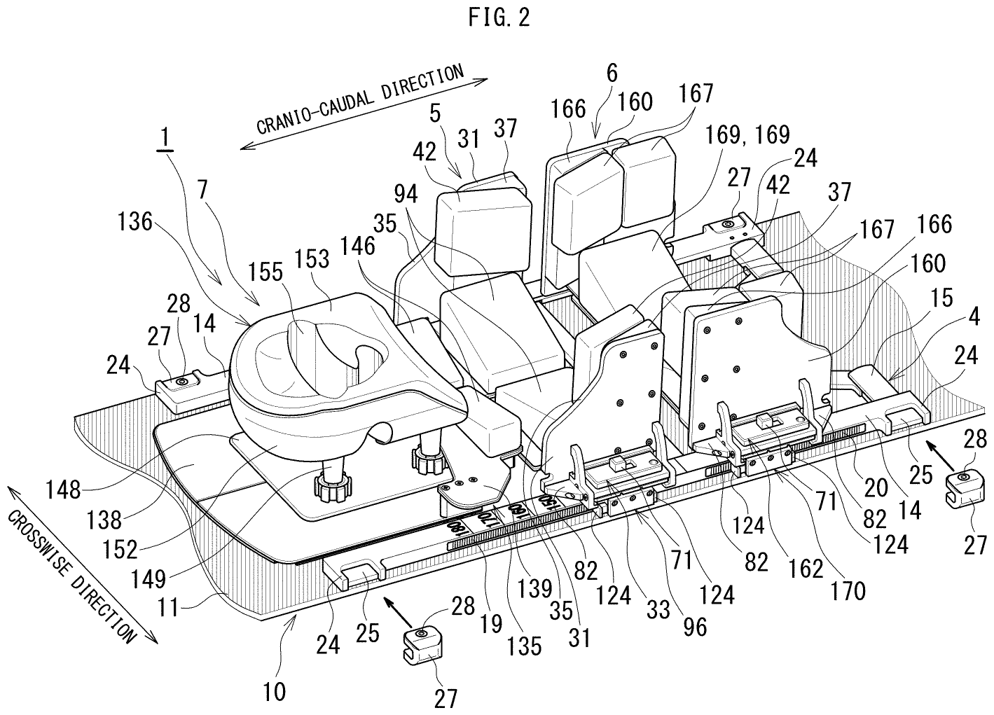

As illustrated in FIGS. 1 and 2, the supporting device 1 includes a base unit 4 integrally connected to an operating table 10, a chest pressing unit 5 including a pair of chest pressing bodies 31 and integrally connected to the base unit 4, a waist pressing unit 6 including a pair of waist pressing bodies 160 and integrally connected to the base unit 4, and a head support unit 7 including a head support 136 and integrally connected to the chest pressing unit 5. In the following description, a direction orthogonal to a cranio-caudal direction of a patient is referred to as a left-right direction. Moreover, the head side will be referred to as a cranial side, and the leg side will be referred to as a caudal side.

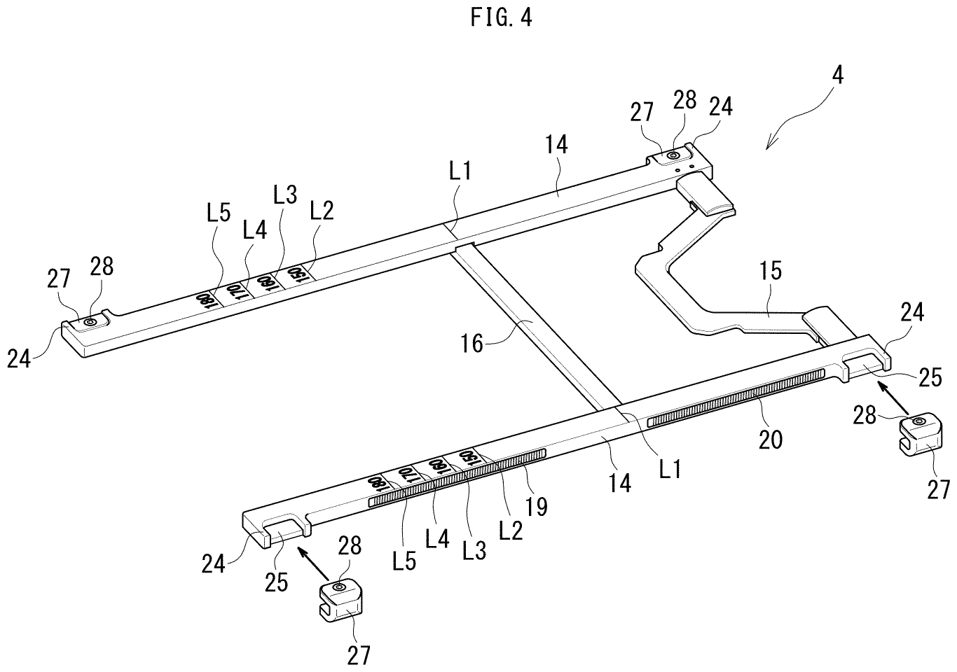

Referring to FIG. 4, the base unit 4 includes a pair of rail members 14 disposed at an interval in the left-right direction to extend in the cranio-caudal direction, a first coupling member 15 connecting the caudal side ends of the pair of rail members 14, and a second coupling member 16 connecting approximately the central portions in the longitudinal direction of the pair of rail members 14. The pair of rail members 14, the first coupling member 15, and the second coupling member 16, constituting the base unit 4 are formed of materials, which are X-ray permeable. For example, a synthetic resin is used as the material, which is X-ray permeable. In the present embodiment, PEEK which is super engineering plastics is used. The rail member 14 is formed in a planar form elongated in the cranio-caudal direction. A chest unit-lock concavoconvex section 19 for fixing the chest pressing unit 5 at an arbitrary position in the cranio-caudal direction is provided on the outer surface in the left-right direction on the cranial side so as to extend a predetermined length.

A waist unit-lock concavoconvex section 20 for fixing the waist pressing unit 6 at an arbitrary position in the cranio-caudal direction is provided on the outer surface in the left-right direction on the caudal side so as to extend a predetermined length. A reference line L1 indicating the initial position in the cranio-caudal direction of the waist pressing unit 6 and reference lines L2 to L5 indicating the initial positions in the cranio-caudal direction of the chest pressing unit 5 are provided on the upper surface of each rail member 14. The reference line L1 is the position at which the movement toward the cranial side of the waist pressing unit 6 is restricted. The reference line L2 corresponds to a patient whose height is approximately 150 cm, the reference line L3 corresponds to a patient whose height is approximately 160 cm, the reference line L4 corresponds to a patient whose height is approximately 170 cm, and the reference line L5 corresponds to a patient whose height is approximately 180 cm. These reference lines L1 to L5 are lines that serve as references. In the present embodiment, an interval is formed between the chest unit-lock concavoconvex section 19 and the waist unit-lock concavoconvex section 20. However, the chest unit-lock concavoconvex section 19 and the waist unit-lock concavoconvex section 20 may be connected continuously. In this way, the movable range along the pair of rail members 14, of the chest pressing unit 5 and the waist pressing unit 6 can be increased. A scale for grasping the position or the moving distance in the cranio-caudal direction of the chest pressing unit 5 and the waist pressing unit 6 may be provided on the upper surface of each rail member 14.

A wide-width section 24 of which the width in the left-right direction is larger than the other portions is formed at both ends in the longitudinal direction (the cranio-caudal direction) of the rail member 14. A coupling concave section 25 is formed in the wide-width section 24 of the rail member 14 so as to open the upper surface and the outer side surfaces thereof. A clamp member 27 which is a connection means that detachably connects a top plate 11 of the operating table 10 and the rail member 14 is fitted to the coupling concave section 25. The clamp member 27 is formed in a C-shape in a front view. The clamp member 27 has female threads (not illustrated) that passes an upper lateral wall thereof in an up-down direction. A fixing screw 28 is screwed into the female threads. The first coupling member 15 has a planar form and is formed in an approximately C-shape in a plan view, protruding toward the cranial side. The second coupling member 16 is formed in a planar form extending in the left-right direction. In the present embodiment, the clamp member 27 is used as a connection means for connecting the supporting device 1 and the operating table 10, specifically, as a connection means for integrally connecting the pair of rail members 14 of the base unit 4 and the top plate 11 of the operating table 10. However, without being limited thereto, the pair of rail members 14 of the base unit 4 and the top plate 11 of the operating table 10 may be integrally connected using a side rail (not illustrated) provided in advance in the longitudinal direction at an interval from the side surface of the operating table 10.

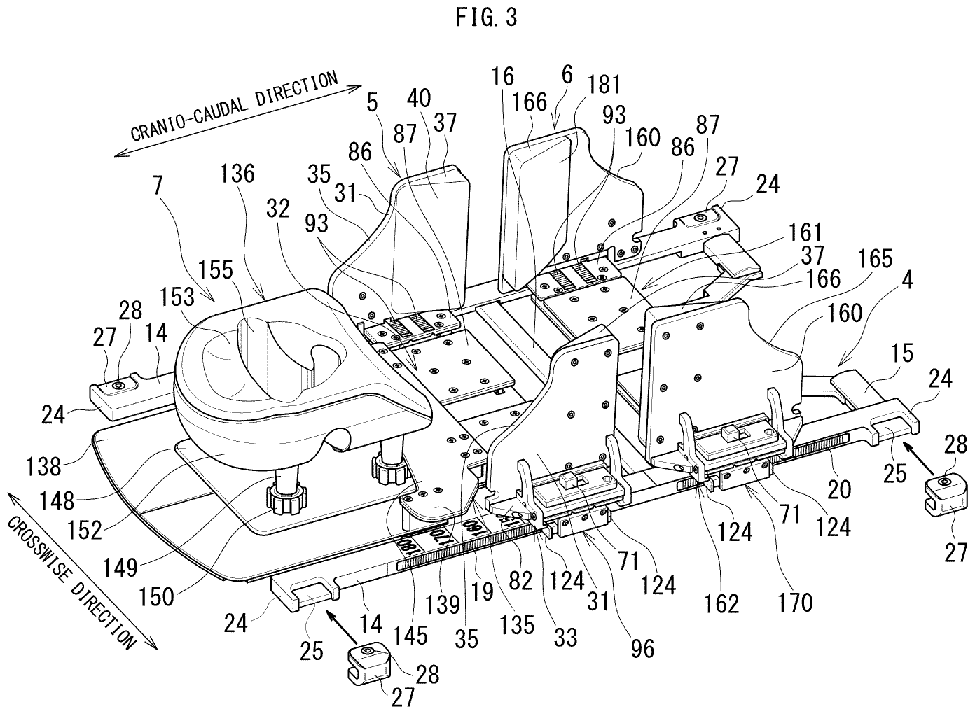

As illustrated in FIGS. 2 and 3, the chest pressing unit 5 includes a pair of chest pressing bodies 31 disposed at an interval in the left-right direction, a chest support 32 supporting the pair of chest pressing bodies 31 so as to be movable closer to or away from each other, and a chest presser fixing means 33 integrally connected to the chest pressing body 31 so as to fix the chest pressing body 31 at an arbitrary position or release the same so as to be movable in relation to the chest support 32 in response to a slide operation of a switch portion 71 by an operator. The pair of chest pressing bodies 31 and the chest presser fixing means 33 are formed of a material capable of transmitting X-rays. For example, a synthetic resin is used as the material capable of transmitting X-rays. In the present embodiment, PEEK which is super engineering plastics is used.

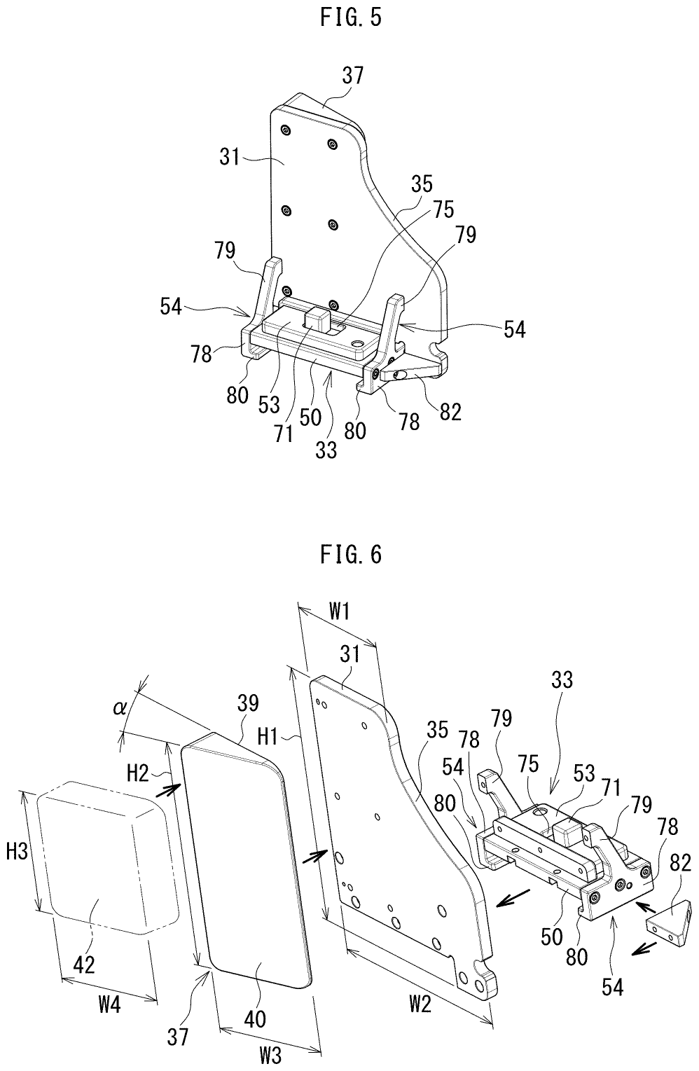

Referring to FIGS. 5 and 6, the chest pressing body 31 is formed in a planar form. The chest pressing body 31 is formed in an approximately rectangular form in a side view as a whole, and a cutout 35 whose height decreases gradually from the apex thereof toward the cranial side is formed on the cranial side. Due to this cutout 35, when the chest of the patient and the vicinity thereof is pressed by the chest pressing body 31, the chest pressing body 31 does not contact and press a region near the armpit of the patient. In other words, due to the cutout 35, when the chest pressing body 31 presses the vicinity of the armpit of the patient, compression of the axillary nerve is prevented or the compression will not occur. Moreover, the chest pressing body 31 is formed so that a difference between an upper-side width W1 and a lower-side width W2 is within a range of approximately 65 mm to 75 mm in order to avoid contact with the vicinity of the armpit of the patient. In the present embodiment, the difference between the upper-side width W1 and the lower-side width W2 of the chest pressing body 31 is set to approximately 70 mm. Referring to FIG. 1, the height H1 of the chest pressing body 31 is set to be at least higher than the back of the patient in a state in which the patient is placed on the supporting device 1 in a prone position. The chest pressing body 31 is prepared in two types having large and small widths (W1 and W2). The large and small chest pressing bodies 31 can be used arbitrarily depending on the position of the curve of the scoliosis of the patient. For example, the chest pressing body 31 having a large width (W1, W2) is selected for a patient with a thoracic vertebra curve or a thoracolumbar curve, and the chest pressing body 31 having a small width (W1, W2) is selected for a patient with a lumbar vertebra curve.

A non-slip projection 37 as an anti-slip means is connected to the chest pressing body 31 over an entire inner surface on the caudal side from the cutout 35. The non-slip projection 37 is formed in a planar form having a bottom surface 39 and an inclined surface 40. The non-slip projection 37 has a width (the width of the bottom surface 39) W3 approximately the same as the width W1 of the chest pressing body 31 and has a height H2 approximately lower than the height H1 of the chest pressing body 31. The bottom surface 39 of the non-slip projection 37 abuts the inner surface of the chest pressing body 31 so that the upper ends match approximately, and the inclined surface 40 of which the height is the highest at the caudal side end and gradually decreases toward the cranial side is connected to the bottom surface 39 so as to be positioned on the body surface side of the patient. The inclination angle α of the inclined surface 40 with respect to the bottom surface 39 of the non-slip projection 37 is set to be within a range of 5 to 45°. This inclination angle α is preferably set depending on the size (physique) of the patient's body. Moreover, in the present embodiment, the height H2 of the non-slip projection 37 is set to be slightly lower than the height H1 of the chest pressing body 31. However, the height H2 may be formed so as to be approximately equal to the height H3 of a chest-lateral support pad 42 to be described later. In the case of this embodiment, the non-slip projection 37 is connected to the upper part of the chest pressing body 31 as described above. Due to this, when the pair of chest pressing bodies 31 move closer to each other, the non-slip projection 37 will not interfere with the chest-front support pads 94 to be described later, and the chest of the patient and the vicinity thereof can be easily pressed from both sides by the pair of chest pressing bodies 31.

Due to the non-slip projection 37, even when the chest pressing unit 5 is slid toward the cranial side and the patient is pulled toward the caudal side, the pair of chest pressing bodies 31 will not slide in the cranio-caudal direction from both left and right side surfaces of the chest of the patient, and the pair of chest pressing bodies 31 can be integrally brought into close contact with the chest of the patient and the vicinity thereof via the chest-lateral support pads 42 to be described later. In the present embodiment, the planar non-slip projection 37 having the bottom surface 39 and the inclined surface 40 is used as the anti-slip means. However, a concave-curved section that is recessed inward may be formed in the non-slip projection 37 instead of the inclined surface 40. Moreover, the chest pressing body 31 as an anti-slip means is attached to the rail member 14 so as to be rotatable about a rotation axis using a direction vertical to an extension direction of the rail member 14 as the rotation axis. The pair of chest pressing bodies 31 may be rotated to a position at which the chest pressing bodies exhibits a C-shape in a plan view (that is, so that the distance between the pair of chest pressing bodies 31 gradually decreases toward the caudal side) and be fixed at that position.

As illustrated in FIGS. 1, 2, and 6, the chest-lateral support pad 42 that is highly flexible is disposed between the body surface of the patient and the chest pressing body 31 including the non-slip projection 37. The chest-lateral support pad 42 is formed in a block form and is detachably attached to the upper part of the chest pressing body 31 (the non-slip projection 37). The chest-lateral support pad 42 is formed of a material that transmits X-rays. The chest-lateral support pad 42 is formed of a bag filled with a soft urethane mat. The use of the chest-lateral support pad 42 prevents pressure ulcer on the body surface of the patient even when the chest of the patient and the vicinity thereof are pressed by the chest pressing body 31. The height H3 of the chest-lateral support pad 42 is set such that the chest-lateral support pad 42 does not interfere with the chest-front support pads 94 to be described later when the pair of chest pressing bodies 31 moves closer to each other together with the chest-lateral support pads 42. The width W4 of the chest-lateral support pad 42 is approximately the same as the width W3 of the non-slip projection 37.

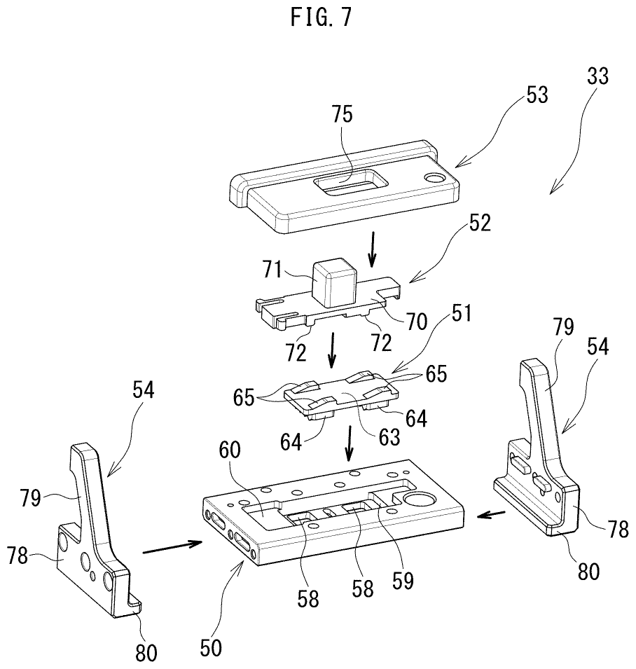

As illustrated in FIGS. 5 to 7, the chest presser fixing means 33 is integrally connected to a lower end of the outer surface of the chest pressing body 31. The chest presser fixing means 33 includes a support plate 50 having an approximately rectangular form in a plan view, a lock member 51 accommodated in the support plate 50 and having a pair of concavoconvex sections 64 that appears and disappears from a lower surface of the support plate 50, a switch member 52 as a slide switch that is slidable in the longitudinal direction with respect to the support plate 50 and presses the lock member 51 toward the lower side, a cover member 53 that accommodates the lock member 51 and the switch member 52 between the support plate 50 and the cover member 53, and a pair of reinforcing ribs 54 connected to both end surfaces in the longitudinal direction of the support plate 50. As understood from FIG. 7, two penetrating sections 58 that penetrate through the support plate 50 in an up-down direction are formed at an interval in the longitudinal direction. A first housing concavity 59 that supports the lock member 51 so as to be movable in the up-down direction is formed around each penetrating section 58. A second housing concavity 60 that supports the switch member 52 so as to be slidable in the longitudinal direction is formed around the first housing concavity 59.

The lock member 51 includes a planar lock body portion 63, a pair of concavoconvex sections 64 integrally protruding toward from the lower surface of the lock body portion 63, and a plurality of cam portions 65 integrally protruding upward from the upper surface of the lock body portion 63. The lock body portion 63 has a planar form and is formed in an approximately rectangular form in a plan view. The lock body portion 63 is accommodated in the first housing concavity 59 of the support plate 50. A pair of concavoconvex sections 64 is formed at an interval in the longitudinal direction. The concavoconvex sections 64 extend in the lateral direction of the lock body portion 63. The pair of concavoconvex sections 64 is inserted into the penetrating sections 58 of the support plate 50 so as to freely appear and disappear from the lower surface of the support plate 50. A pair of cam portions 65 is formed at an interval in the longitudinal direction so as to correspond to the pair of concavoconvex sections 64. The cam portions 65 are divided in the lateral direction.

The switch member (slide switch) 52 includes a planar switch body portion 70 and a switch portion 71 integrally protruding upward from the upper surface of the switch body portion 70. A pair of pressing portions 72 is formed on the lower surface of the switch body portion 70 at an interval in the longitudinal direction. The switch body portion 70 is accommodated in the second housing concavity 60 of the support plate 50 so as to be movable in the longitudinal direction. The switch portion 71 is formed in a columnar form. A longhole 75 in which the switch portion 71 of the switch member 52 is inserted so as to be slidable in the cranio-caudal direction (longitudinal direction) is formed in the cover member 53. The cover member 53 is connected to the support plate 50 in a state in which the lock member 51 and the switch member 52 are accommodated between the support plate 50 and the cover member 53.

The pair of reinforcing ribs 54 is connected to both side surfaces of the support plate 50. The reinforcing rib 54 includes a support body portion 78 fixed to an end surface in the longitudinal direction of the support plate 50, a reinforcing arm 79 extending from the upper surface of the support body portion 78 toward the chest pressing body 31 and having a distal end connected to the chest pressing body 31, and a receiving section 80 protruding from the lower end of the support body portion 78 toward the support plate 50 and having a gap formed between the receiving section 80 and the lower surface of the support plate 50. In the chest presser fixing means 33, when the switch portion 71 of the switch member 52 protruding upward from the longhole 75 of the cover member 53 is slid in a lock direction in the longitudinal direction of the longhole 75, the switch member 52 is slid in the lock direction in the longitudinal direction and the pair of pressing portions 72 of the switch body portion 70 presses the pair of cam portions 65 of the lock member 51 from the upper side. As a result, the lock member 51 moves downward, the pair of concavoconvex sections 64 protrudes downward from the penetrating sections 58 of the support plate 50, and that state is maintained. The lock direction of the slide portion 71 of the switch member 52 in the chest presser fixing means 33 is a direction (the cranial side) toward the head section.

On the other hand, when the switch portion 71 of the switch member 52 is slid in an unlock direction in the longitudinal direction of the longhole 75 of the cover member 53, since the pair of pressing portions 72 of the switch body portion 70 cannot press the pair of cam portions 65 of the lock member 51, the lock member 51 can freely move in the up-down direction (that is, a free state). The unlock direction of the slide portion 71 of the switch member 52 in the chest presser fixing means 33 is a direction (the caudal side) toward the legs. Moreover, the chest presser fixing means 33 is integrally connected to the lower end of the outer surface of the chest pressing body 31. Specifically, the distal ends of the reinforcing arms 79 of the pair of reinforcing ribs 54 as well as the cover member 53 of the chest presser fixing means 33 are connected to the outer surface of the chest pressing body 31, whereby both chest pressing bodies 31 are integrally connected. Furthermore, as understood from FIGS. 3 and 5, the lower end of the outer surface of the chest pressing body 31 and the reinforcing rib 54 on the cranial side are connected by a reinforcing plate 82 having a triangular form in a plan view.

Due to the reinforcing arms 79 and the reinforcing plate 82, when the chest of the patient and the vicinity thereof are pressed from both sides in the left-right direction by the pair of chest pressing bodies 31, the pressing force from the pair of chest pressing bodies 31 can be appropriately transmitted to the chest of the patient and the vicinity thereof while preventing the pair of chest pressing bodies 31 from being tilted outward by the reaction force. As illustrated in FIG. 3, the chest pressing body 31 integrated with the chest presser fixing means 33 is detachably attached to the chest support 32 extending in the left-right direction.

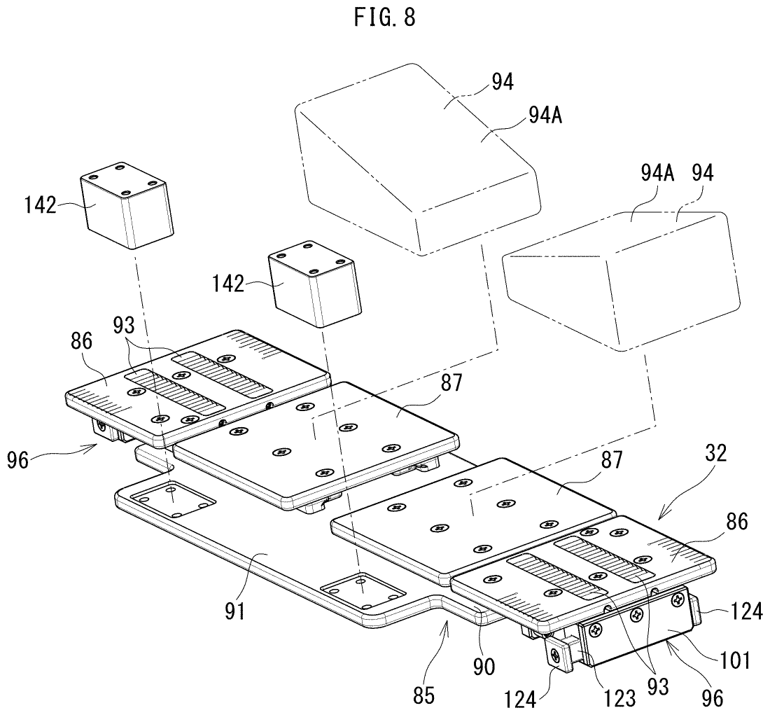

The components of the chest support 32 to be described later are formed of a material capable of transmitting X-rays. For example, a synthetic resin is used as the material capable of transmitting X-rays. In the present embodiment, a phenol resin (Bakelite (trademark)) is used. As illustrated in FIGS. 3 and 8, the chest support 32 includes a base plate 85 extending in the left-right direction, a pair of locking plates 86 connected to both ends in the left-right direction on the base plate 85, and a pair of slide plates 87 disposed on the inner sides of the pair of locking plates 86. The base plate 85 includes, at both ends in the left-right direction, a main plate portion 90 having an approximately rectangular form in a plan view to which the pair of locking plates 86 is connected, and an auxiliary plate portion 91 protruding toward the cranial side from the main plate portion 90, having an approximately rectangular form in a plan view, and having a shorter length (width) in the left-right direction than the main plate portion 90. Quadrangular prism members 142 are connected to both ends in the left-right direction of the auxiliary plate portion 91.

The locking plate 86 is formed in an approximately rectangular form in a plan view. The ends in the left-right direction of the locking plate 86 are connected to the upper surface at the ends in the left-right direction of the base plate 85 (the main plate portion 90). Lock concavoconvex sections 93 are formed on the upper surface of the locking plate 86 so as to extend in the left-right direction. A pair of locking concavoconvex sections 93 is provided at an interval in the cranio-caudal direction. Scales for measuring the position of the chest pressing body 31 are formed at both ends in the cranio-caudal direction on the upper surface of the locking plate 86. The pair of slide plates 87 is supported so as to be movable closer to or away from the base plate 85. The widths (the lengths in the cranio-caudal direction) of the slide plate 87 and the locking plate 86 are approximately the same and are set to be slightly smaller than the width (the length in the cranio-caudal direction) of the main plate portion 90 of the base plate 85.

Chest-front support pads 94 for supporting the anterior chest of the patient are detachably attached to the pair of slide plates 87. The chest-front support pad 94 is formed in a block form and the upper surface thereof is formed as an inclined surface 94A whose height gradually decreases from one end in the left-right direction toward the other end. The chest-front support pad 94 is formed of a material that transmits X-rays. The chest-front support pad 94 is formed of a bag filled with a hard urethane mat. The chest-front support pads 94 are attached to the pair of slide plates 87 so as to exhibit a V-shape in a front view as a whole due to the inclined surfaces 94A. As understood from FIG. 2, the chest-front support pads 94 will not interfere with the chest-lateral support pads 42 when the pair of chest pressing bodies 31 moves closer to each other together with the chest-lateral support pads 42. In the present embodiment, the pair of slide plates 87 is supported on the base plate 85 so as to be movable closer to or away from each other. However, it is not always necessary that the slide plates 87 slide on the base plate 85. That is, when the pair of slide plates 87 are supported on the base plate 85 so as to be movable closer to or away from each other, and the supporting device 1 operates as will be described later, there may be a concern that the force that pulls the skin of the anterior chest of the patient toward the center in the left-right direction acts and the influence on the skin increases. If there is such a concern, it is not necessary to provide the pair of slide plates 87.

As illustrated in FIGS. 1 to 3, the chest pressing body 31 including the chest presser fixing means 33 is disposed in relation to the chest support 32 such that the locking plate 86 of the chest support 32 is sandwiched between the support plate 50 of the chest presser fixing means 33 and the receiving sections 80 of the pair of reinforcing ribs 54. As a result, since the lock member 51 enters a free state in the up-down direction in a state in which the switch portion 71 of the chest presser fixing means 33 is slid in the unlock direction in the longitudinal direction of the longhole 75, the chest pressing body 31 including the chest presser fixing means 33 can freely move in the left-right direction along the locking plate 86.

On the other hand, when the chest pressing body 31 is to be fixed at an arbitrary position in the left-right direction of the locking plate 86, and the switch portion 71 of the chest presser fixing means 33 is slid in the lock direction in the longitudinal direction of the longhole 75, as described above, the switch member 52 is slid in the longitudinal direction and the pair of pressing portions 72 of the switch body portion 70 presses the pair of cam portions 65 of the lock member 51 from the upper side. As a result, the lock member 51 moves downward, and the pair of concavoconvex sections 64 of the lock member 51 protrudes downward from the penetrating portions 58 of the support plate 50 to be fitted to the pair of locking concavoconvex sections 93 of the locking plate 86 of the chest support 32 and is fixed at that position. As described above, the pair of chest pressing bodies 31 can move independently in relation to the chest support 32 due to the action of the chest presser fixing means 33.

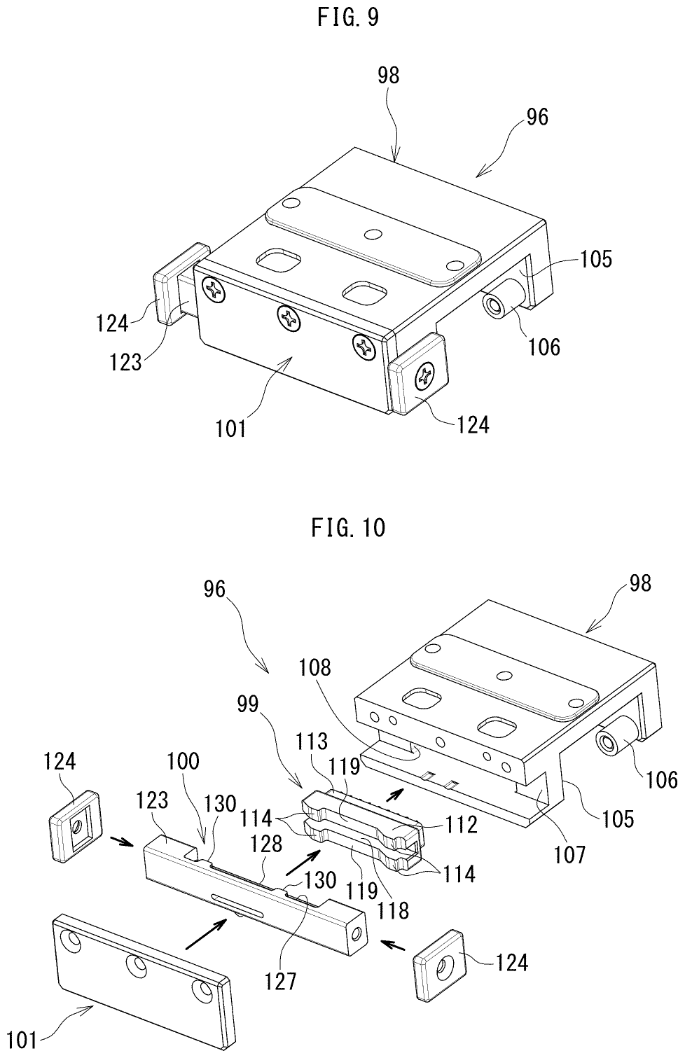

As illustrated in FIG. 8, a chest pressing unit fixing means 96 is integrally connected to the lower surface at the end in the left-right direction of each locking plate 86 of the chest support 32. The chest pressing unit fixing means 96 fixes the chest pressing unit 5 at an arbitrary position in the cranio-caudal direction or releases the chest pressing unit 5 so as to be movable in relation to the pair of rail members 14 in response to a slide operation of the switch portion 124 by an operator. The components of the chest pressing unit fixing means 96 to be described later are formed of a material capable of transmitting X-rays. For example, a synthetic resin is used as the material capable of transmitting X-rays. In the present embodiment, PEEK which is super engineering plastics is used. As illustrated in FIGS. 9 and 10, the chest pressing unit fixing means 96 includes a slider 98 that slides along the rail member 14 of the base unit 4, a lock member 99 accommodated in the slider 98, a switch member 100 as a slide switch that is slidable in the cranio-caudal direction in relation to the slider 98 and presses the lock member 99, and a cover member 101 that accommodates the lock member 99 and the switch member 100 between the slider 98 and the cover member 101.

A housing concavity 105 having a C-shape in a front view that accommodates the rail member 14 is formed in the lower surface of the slider 98 in the cranio-caudal direction. In the housing concavity 105, a pair of cylindrical guiding portions 106 that abuts the rail member 14 to guide the rail member 14 protrudes from a wall on the opposite side from the cover member 101 (only one guiding portion is illustrated in FIG. 9). The upper surface of the slider 98 is connected to the end in the left-right direction of the locking plate 86 of the chest support 32.

A supporting concavity 107 that supports the rod-shaped switch member 100 so as to be movable in the cranio-caudal direction is formed in an outer surface in the left-right direction of the slider 98. A penetrating longhole 108 communicating with the housing concavity 105 is formed in a bottom portion of the supporting concavity 107. The penetrating longhole 108 is formed as a through hole that is long in the cranio-caudal direction. The lock member 99 includes a planar lock body portion 112, a concavoconvex section 113 integrally protruding from the lock body portion 112 toward the slider 98, and a plurality of cam portions 114 integrally protruding from the lock body portion 112 toward the cover member 101. The lock body portion 112 is planar and a supporting groove 118 extending in the cranio-caudal direction is formed in a surface close to the cover member 101. A pair of walls 119 is formed on the upper and lower sides with the supporting groove 118 disposed therebetween.

The cam portions 114 protrude from surfaces of the pair of walls 119 of the lock body portion 112 close to the cover member 101. A pair of cam portions 114 is formed at an interval in the cranio-caudal direction (longitudinal direction). The concavoconvex section 113 extends on the surface of the lock body portion 112 close to the slider 98 in the cranio-caudal direction. The concavoconvex section 113 can freely appear and disappear from the penetrating longhole 108 of the slider 98 into the housing concavity 105. The lock member 99 is supported in the penetrating longhole 108 of the slider 98 so as to be movable closer to and away from the rail member 14.

The switch member (slide switch) 100 includes a columnar switch body portion 123 extending in the cranio-caudal direction and a pair of switch portions 124 integrally fixed to both ends in the longitudinal direction of the switch body portion 123. A concaved section 127 having a C-shape in a plan view that opens the upper surface, the lower surface, and the surface close to the slider 98 is formed in the switch body portion 123. An elongated convex portion 128 that extends in the cranio-caudal direction and is fitted to the supporting groove 118 provided in the lock member 99 is formed in a central portion in the up-down direction of the bottom portion of the concaved section 127. A pair of pressing portions 130 is provided at an interval in the cranio-caudal direction so as to protrude from the upper and lower bottom portions of the concaved section 127 about the convex portion 128. The switch body portion 123 has the elongated convex portion 128 fitted to the supporting groove 118 of the lock member 99 and is accommodated in the supporting concavity 107 of the slider 98 so as to be movable in the cranio-caudal direction in relation to the slider 98.

The cover member 101 is connected to the slider 98 in a state in which the lock member 99 and the switch member 100 are accommodated between the slider 98 and the cover member 101. In the chest pressing unit fixing means 96, when any one of the switch portions 124 of the switch member 100 is slid in the lock direction in the cranio-caudal direction, the switch member 100 slides in the lock direction in the cranio-caudal direction and the pair of pressing portions 130 of the switch body portion 123 presses the pair of cam portions 114 of the lock member 99. As a result, the lock member 99 slides towards the slider 98, the concavoconvex section 113 protrudes from the penetrating longholes 108 of the slider 98 into the housing concavity 105, and that state is maintained. The lock direction of the chest pressing unit fixing means 96 by the switch member 100 is a direction (the cranial side) toward the head section. On the other hand, when the other switch portion 124 of the switch member 100 is slid in the unlock direction in the cranio-caudal direction, the switch body portion 123 slides in the unlock direction in the cranio-caudal direction, the pair of pressing portions 130 of the switch body portion 123 cannot press the pair of cam portions 114 of the lock member 99, and the lock member 99 can freely move in the left-right direction (that is, a free state). The unlock direction of the chest pressing unit fixing means 96 by the switch member 100 is a direction (the caudal side) toward the legs.

As illustrated in FIGS. 1 to 3, the chest pressing unit fixing means 96 is integrally connected to the lower surface at the end in the left-right direction of each locking plate 86 of the chest support 32, and the pair of rail members 14 is fitted to the housing concavitys 105 of the pair of chest pressing unit fixing means 96. In a state in which the switch portions 124 (the switch members 100) of the pair of chest pressing unit fixing means 96 are slid in the unlock direction, the lock member 99 of the chest pressing unit fixing means 96 enters a free state, and the chest pressing unit 5 including the chest pressing unit fixing means 96 can freely move along the pair of rail members 14.

On the other hand, when the chest pressing unit 5 is to be fixed at an arbitrary position in the cranio-caudal direction of the pair of rail members 14 (the chest unit-lock concavoconvex sections 19), and the switch portions 124 (the switch members 100) of the pair of chest pressing unit fixing means 96 are slid in the lock direction in the cranio-caudal direction, as described above, the switch member 100 slides in the lock direction in the cranio-caudal direction, and the pair of pressing portions 130 of the switch body portion 123 presses the pair of cam portions 114 of the lock member 99. As a result, the lock member 99 slides toward the slider 98, the concavoconvex section 113 protrudes from the penetrating longholes 108 of the slider 98 to the housing concavity 105 to be fitted to the chest unit-lock concavoconvex sections 19 of the pair of rail members 14 and is fixed at that position. In this manner, the chest pressing unit 5 can freely move along the rail member 14 according to the operation of the chest pressing unit fixing means 96 and can be fixed at an arbitrary position within the range of the chest unit-lock concavoconvex section 19 provided in the rail member 14.

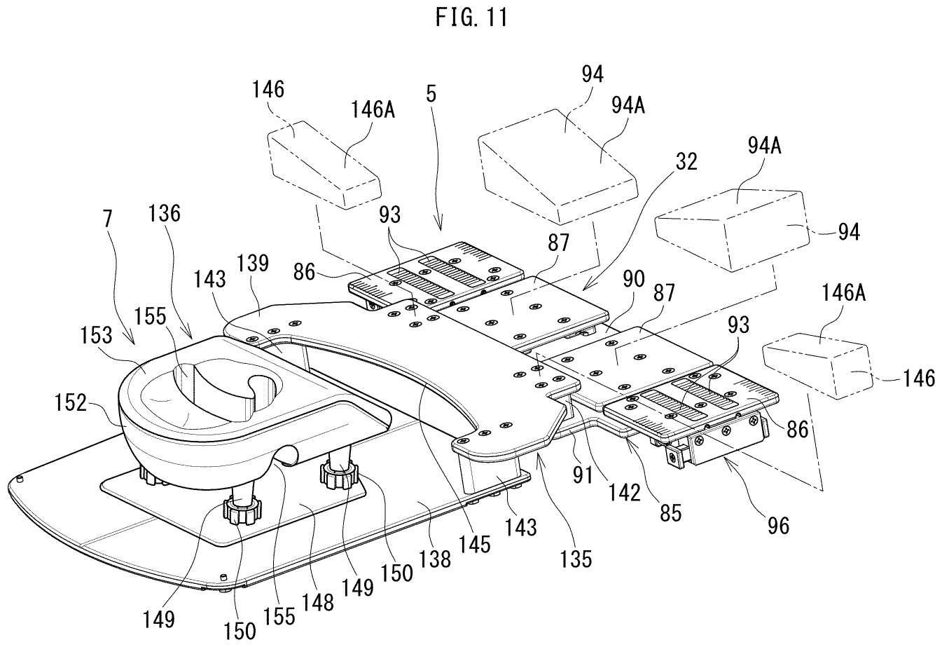

As illustrated in FIG. 11, the head support unit 7 is integrally connected to the chest support 32 of the chest pressing unit 5. Specifically, the head support unit 7 includes a support-plate unit 135 integrally connected to the chest support 32 and a head support 136 supported by the support-plate unit 135. The components of the support-plate unit 135 to be described later are formed of a material capable of transmitting X-rays. For example, a synthetic resin is used as the material capable of transmitting X-rays. In the present embodiment, a phenol resin (Bakelite (trademark)) is used.

The support-plate unit 135 includes a head supporting plate 138 extending toward the lower side of the head section of the patient and an intermediate supporting plate 139 integrally connected to the auxiliary plate portion 91 of the chest support 32 and the head supporting plate 138 and disposed at a position of a predetermined height from the head supporting plate 138 and the chest support 32. The head supporting plate 138 is formed in an approximately rectangular form that is long in the cranio-caudal direction. As described above, the quadrangular column members 142 (see FIG. 8) are connected to both ends in the left-right direction of the auxiliary plate portion 91 of the chest support 32. The quadrangular column members 143 are also connected to both ends in the left-right direction of the caudal side ends of the head supporting plate 138.

The width on the cranial side of the intermediate supporting plate 139 is approximately the same as the width (the length in the left-right direction) of the head supporting plate 138 and a concave-curved section 145 is formed on the cranial side. In the present embodiment, the width (the length in the left-right direction) of the intermediate supporting plate 139 is approximately the same as the width (the length in the left-right direction) of the head supporting plate 138. However, in consideration of a contact state with the armpit of the patient, the width of the intermediate supporting plate 139 may be set to be shorter than the width of the head supporting plate 138. The concave-curved section 145 corresponds to a relief concaved section. As will be described later, after the supporting device 1 is operated to correct spinal deformities of the patient, when force of contracting the body of the patient in the cranio-caudal direction is applied, the movement of the head support 136 toward the caudal side will not be interfered due to the concave-curved section 145 when the head section is moved toward the caudal side together with the head support 136. The width on the caudal side of the intermediate supporting plate 139 is approximately the same as the width of the auxiliary plate portion 91 of the chest support 32, and the caudal side of the intermediate supporting plate 139 protrudes in an approximately rectangular form. Both ends in the left-right direction on the caudal side of the intermediate supporting plate 139 are connected to the quadrangular column members 142 protruding upward from the auxiliary plate portion 91 of the chest support 32. On the other hand, both portions on the cranial side of the intermediate supporting plate 139 in the left-right direction about the concave-curved section 145 are connected to the quadrangular column members 143 protruding upward from the head supporting plate 138.

A pair of chest-front support pads 146 is detachably attached to both sides in the left-right direction on the upper surface on the caudal side of the intermediate supporting plate 139. The chest-front support pad 146 is formed in a block form, and the upper surface thereof is formed as an inclined surface 146A whose height gradually decreases from one end in the left-right direction toward the other end. The chest-front support pad 146 is formed of a material that transmits X-rays. The chest-front support pad 146 is formed of a bag filled with a hard urethane mat. The pair of chest-front support pads 146 is attached to both sides in the left-right direction on the upper surface on the caudal side of the intermediate supporting plate 139 so as to exhibit a V-shape in a front view as a whole due to the inclined surfaces 146A.

A mirror member 148 is disposed on the head supporting plate 138 of the head support unit 7. The head support 136 is supported on the mirror member 148 via a plurality of supporting pole portions 149 having a predetermined height. The supporting pole portions 149 are connected to the lower surface of the head support 136. An operator can move the head support 136 on the mirror member 148 together with the supporting pole portion 149. A nut member 150 is integrally connected to the lower part of the supporting pole portion 149, and the height of the head support 136 can be adjusted by rotating the nut member 150. The head support 136 includes a head supporting section 152 having a concaved section that supports and surrounds the face of the patient and a flexible cushion portion 153 disposed in the concaved section of the head supporting section 152. The head supporting section 152 and the cushion portion 153 including the supporting pole portions 149 are formed of a material capable of transmitting X-rays. Openings 155 are formed in portions of the head supporting section 152 and the cushion portion 153 corresponding to the eyes and the mouth of the patient. Since the head support unit 7 is integrally connected to the chest pressing unit 5, the head support unit 7 can freely move in the cranio-caudal direction along the pair of rail members 14 together with the chest pressing unit 5.

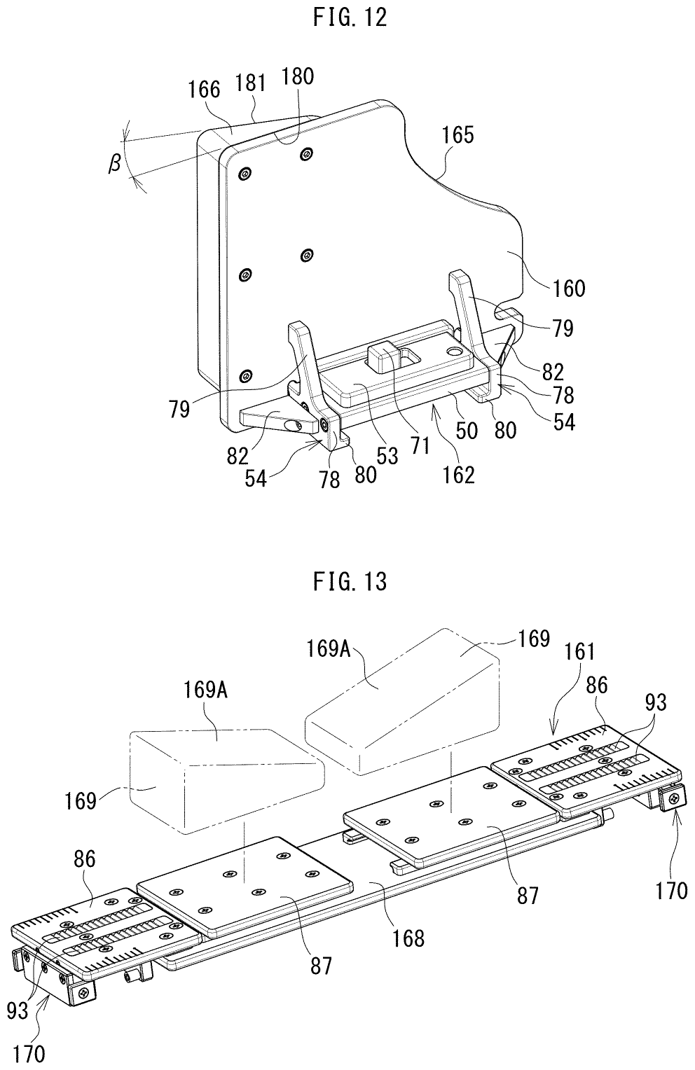

As illustrated in FIGS. 1 to 3, the waist pressing unit 6 includes a pair of waist pressing bodies 160 disposed at an interval in the left-right direction, a waist support 161 that supports the pair of waist pressing bodies 160 so as to be movable closer to and away from each other, and a waist pressing body fixation device 162 integrally connected to the waist pressing body 160 so as to fix the waist pressing body 160 at an arbitrary position or release the same so as to be movable in relation to the waist support 161 in response to a slide operation of the switch portion 71 by an operator. Referring to FIG. 12, the waist pressing body 160 is formed in a planar form. The waist pressing body 160 is formed in an approximately rectangular form in a side view as a whole, and a notch portion 165 whose height decreases gradually from the apex thereof toward the cranial side is formed on the caudal side. In the present embodiment, the cutout 165 is provided in the waist pressing body 160, but it is not always necessary to provide the cutout 165.

The height of the waist pressing body 160 is approximately the same as the chest pressing body 31. The thickness of the waist pressing body 160 is approximately the same as the chest pressing body 31. The width of the waist pressing body 160 is set to be an intermediate width of the two types of widths W2) prepared as the chest pressing body 31. A planar non-slip projection 166 having a bottom surface 180 and an inclined surface 181 is connected to the cranial side of the waist pressing body 160 similarly to the chest pressing body 31 as the anti-slip means. The non-slip projection 166 has the same shape and dimensions as the non-slip projection 37 connected to the chest pressing body 31. The bottom surface 180 of the non-slip projection 166 abuts the inner surface of the waist pressing body 160 so that the upper ends thereof match approximately, and the inclined surface 181 whose height is the highest at the cranial side end and gradually decreases toward the caudal side is connected to the bottom surface 180 so as to be positioned on the body surface side of the patient. The inclination angle β of the inclined surface 181 with respect to the bottom surface 180 of the non-slip projection 166 is set to be within a range of 5 to 45°. This inclination angle β is preferably set depending on the size (physique) of the body of the patient. In the present embodiment, the height of the non-slip projection 166 is set to be slightly lower than the height of the waist pressing body 160. However, the height of the non-slip projection 166 may be set to be approximately the same as the height of a waist-lateral support pad 167 to be described later. In the case of this embodiment, the non-slip projection 166 is connected to an upper part of the waist pressing body 160. Due to this, when the pair of waist pressing bodies 160 moves closer to each other, the non-slip projections 166 will not interfere with the waist-front support pads 169 to be described later, and the waist of the patient and the vicinity thereof can be easily pressed from both sides by the pair of waist pressing bodies 160.

When the waist pressing unit 6 is slid toward the caudal side by the non-slip projection 166 and the patient is pulled toward the cranial side, the pair of waist pressing bodies 160 will not slide from both side surfaces in the left-right direction of the waist of the patient, and the pair of waist pressing bodies 160 can be integrally brought into close contact with the waist of the patient and the vicinity thereof via the waist-lateral support pads 167 to be described later.

As illustrated in FIGS. 1 and 2, a plurality of flexible waist-lateral support pads 167 is disposed in the cranio-caudal direction between the body surface of the patient and the waist pressing body 160 including the non-slip projection 166. In the present embodiment, two waist-lateral support pads 167 are disposed in the cranio-caudal direction so as to abut each other. The waist-lateral support pad 167 is formed in a block form and is detachably attached to the upper part of the waist pressing body 160 (the non-slip projection 166). The waist-lateral support pad 167 is formed of a material that transmits X-rays. The waist-lateral support pad 167 is formed of a bag filled with a soft urethane mat similarly to the chest-lateral support pad 42. The use of the waist-lateral support pad 167 prevents pressure ulcer on the body surface of the patient even when the waist of the patient and the vicinity thereof are pressed by the waist pressing body 160. The height of the waist-lateral support pad 167 is set such that the waist-lateral support pad 167 does not interfere with the waist-front support pads 169 to be described later when the pair of waist pressing bodies 160 moves closer to each other together with the waist-lateral support pads 167.

As illustrated in FIG. 12, the waist pressing body fixation device 162 is integrally connected to the lower end of the outer surface of the waist pressing body 160. The configuration of the waist pressing body fixation device 162 is the same as the configuration of the chest presser fixing means 33, and the description thereof will be omitted appropriately. A lower end on the outer surface of the waist pressing body 160 and the reinforcing rib 54 on the cranial side are connected to the waist pressing body 160 by the reinforcing plate 82, and the lower end on the outer surface of the waist pressing body 160 and the reinforcing rib 54 on the caudal side are connected by the reinforcing plate 82. Due to the pair of reinforcing arms 79 and the pair of reinforcing plates 82, when the waist of the patient and the vicinity thereof are pressed from both sides in the left-right direction by the pair of waist pressing bodies 160, the pressing force from the pair of waist pressing bodies 160 can be appropriately transmitted to the waist of the patient and the vicinity thereof without preventing the pair of waist pressing bodies 160 from being tilted outward by the reaction force. The lock direction of the slide portion 71 of the switch member 52 in the waist pressing body fixation device 162 is a direction (the caudal side) toward the legs. On the other hand, the unlock direction of the slide portion 71 of the switch member 52 in the waist pressing body fixation device 162 is a direction (the cranial side) toward the head section.

As illustrated in FIG. 13, the base plate 168 constituting the waist support 161 is formed in an approximately rectangular form. The other configuration is the same as that of the chest support 32, and the description thereof will be omitted. The waist-front support pads 169 that support the anterior waist of the patient are detachably attached to the pair of slide plates 87 of the waist support 161. The waist-front support pad 169 is formed in a block form similarly to the chest-front support pad 94, and the upper surface thereof is formed as an inclined surface 169A whose height gradually decreases from one end in the left-right direction toward the other end. The waist-front support pad 169 is formed of a material that transmits X-rays. The waist-front support pad 169 is formed of a bag filled with a hard urethane mat. The pair of waist-front support pads 169 is attached to the pair of slide plates 87 so as to exhibit a V-shape in a front view as a whole due to the inclined surfaces 169A. In the waist support 161, the pair of slide plates 87 supported on the base plate 168 so as to be movable close to or away from each other is provided. However, when the supporting device 1 operates as will be described later, there may be a concern that the force that pulls the skin of the anterior waist of the patient toward the center in the left-right direction acts and the influence on the skin increases. If there is such a concern, it is not necessary to provide the pair of slide plates 87.

As illustrated in FIG. 2, the waist-front support pad 169 will not interfere with the waist-lateral support pads 167 when the pair of waist pressing bodies 160 moves closer to each other together with the waist-lateral support pads 167. Moreover, as illustrated in FIG. 13, a waist pressing unit fixation device 170 is integrally connected to the lower surface of the end in the left-right direction of the locking plates 86 of the waist support 161. The waist pressing unit fixation device 170 fixes the waist pressing unit 6 at an arbitrary position in the cranio-caudal direction or releases the waist pressing unit 6 so as to be movable in relation to the pair of rail members 14 in response to a slide operation of the switch portion 124 by the operator. The waist pressing unit fixation device 170 has the same configuration as the chest pressing unit fixing means 96, and the description thereof will be omitted appropriately. The waist pressing unit 6 can freely move along the rail member 14 by the operation of the waist pressing unit fixation device 170 and can be fixed to an arbitrary position within the range of the waist unit-lock concavoconvex section 20 provided in the rail member 14.

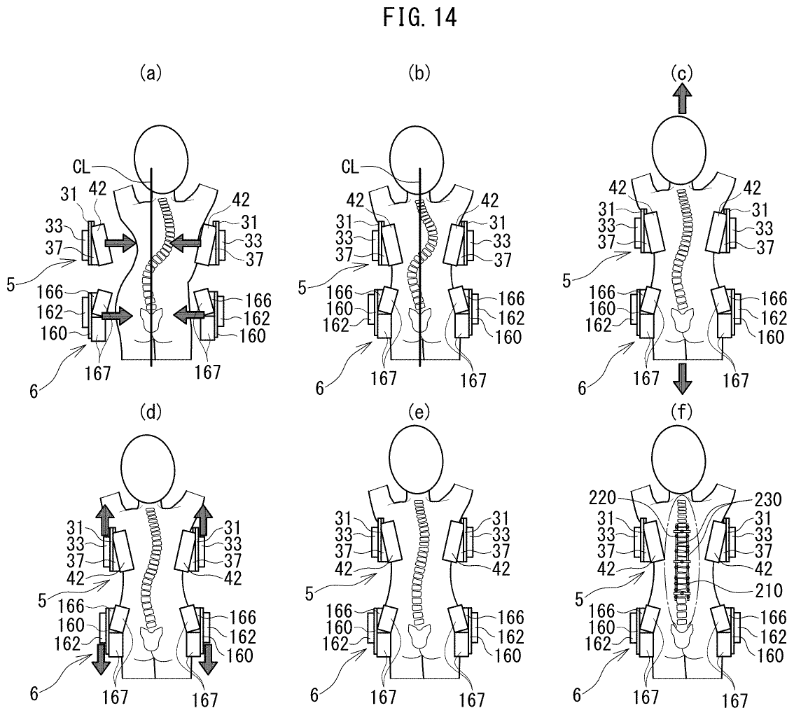

Next, the operation of the supporting device 1 according to the present embodiment will be described with reference to FIGS. 1 to 3 on the basis of FIG. 14. The patient illustrated in FIG. 14 is a scoliosis patient, as schematically illustrated in FIG. 14(a), this scoliosis is a case of a single curve in which the head section is shifted to the right side of the figure from the vertical line CL from the center in the left-right direction of the pelvis, the trunk balance in the left-right direction is lost, and the thoracic vertebra is curved.

First, the supporting device 1 is placed on the operating table 10, and the outer surfaces of the wide-width section 24 of the pair of rail members 14 of the base unit 4 are aligned with both side surfaces in the left-right direction of the top plate 11 of the operating table 10. Subsequently, the clamp members 27 are fitted so as to sandwich the top plate 11 of the operating table 10 and the bottom portions of the coupling concave sections 25 provided in the wide-width section 24 of the rail members 14. After that, the fixing screw 28 of each clamp member 27 is screwed in so that the distal end of the fixing screw 28 is brought into contact with the bottom portion of each connecting concaved section 25 to press the coupling concave section 25 whereby the pair of rail members 14 of the base unit 4 and the supporting device 1 are fixed to the top plate 11 of the operating table 10. At that time, the pair of chest pressing bodies 31 including the chest presser fixing means 33 of the chest pressing unit 5 is detached from the chest support 32. Moreover, the pair of waist pressing bodies 160 including the waist pressing body fixation device 162 of the waist pressing unit 6 is detached from the waist support 161. Furthermore, the waist support 161 is disposed in the pair of rail members 14 so that the cranial side ends of the locking plates 86 of the waist support 161 are positioned at the reference line L1 displayed on the upper surface of the pair of rail members 14. On the other hand, the chest support 32 is disposed in the pair of rail members 14 so that the cranial side ends of the locking plates 86 of the chest support 32 are positioned at any one of the reference lines L2 to L5 corresponding to the height of the patient, displayed on the upper surface of the pair of rail members 14. However, these reference lines L1 to L5 are references only, and there is no particular limitation to the positions.

Subsequently, the patient who is under general anesthesia and who has undergone masking or endotracheal intubation is placed on the pair of chest-front support pads 94 on the chest support 32 (the chest pressing unit 5) of the supporting device 1, the pair of waist-front support pads 169 on the waist support 161 (the waist pressing unit 6), and the pair of chest-front support pads 146 on the intermediate supporting plate 139 of the head support unit 7 in a prone position. Moreover, the head section of the patient is supported and protected by the head support 136 of the head support unit 7. In this case, the upper anterior chest of the patient can be supported at a predetermined height by the intermediate supporting plate 139 of the head support unit 7, and the head section of the patient can be positioned under the chest.

Subsequently, the locking plate 86 of the chest support 32 is sandwiched between the receiving sections 80 of the pair of reinforcing ribs 54 and the support plate 50 of the chest presser fixing means 33 integrated with the chest pressing body 31, and the pair of chest pressing bodies 31 including the chest presser fixing means 33 are disposed in the chest support 32. On the other hand, the locking plate 86 of the waist support 161 is sandwiched between the receiving sections 80 of the pair of reinforcing ribs 54 and the support plate 50 of the waist pressing body fixation device 162 integrated with the waist pressing body 160, and the pair of waist pressing bodies 160 including the waist pressing body fixation device 162 are disposed in the waist support 161.

Subsequently, as illustrated in FIG. 14(a), also referring appropriately to FIGS. 1 and 2, the switch portions 71 of the waist pressing body fixation device 162 of the pair of waist pressing bodies 160 are slid (by one-touch operation) in the unlock direction (the direction toward the head section) so that the pair of waist pressing bodies 160 including the waist pressing body fixation device 162 are moved closer to each other along the waist support 161 (the locking plate 86), and the waist of the patient and the vicinity thereof are pressed from both sides in the left-right direction by the pair of waist pressing bodies 160 via the waist-lateral support pads 167. Subsequently, at that position, the switch portions 71 of the waist pressing body fixation device 162 are slid (by one-touch operation) in the lock direction (the direction toward the legs), whereby the pair of waist pressing bodies 160 are fixed to the waist support 161. In this case, it is desirable that the movement amounts of the pair of waist pressing bodies 160 in the direction closer to each other are set to be approximately the same.

In the pair of waist pressing bodies 160, the waist pressing bodies 160 may be moved in the direction closer to each other substantially at the same time and be fixed to the waist support 161. Alternatively, in the pair of waist pressing bodies 160, after one waist pressing body 160 is fixed in advance to an arbitrary position in relation to the waist support 161, and the other waist pressing body 160 may be moved closer to the one waist pressing body 160 so as to be fixed to the waist support 161.

Similarly, as illustrated in FIG. 14(a), also referring appropriately to FIGS. 1 and 2, the switch portions 71 of the chest presser fixing means 33 of the pair of chest pressing bodies 31 are slid (by one-touch operation) in the unlock direction (the direction toward the legs) so that the pair of chest pressing bodies 31 including the chest presser fixing means 33 are moved closer to each other along the chest support 32 (the locking plate 86), and the chest of the patient and the vicinity thereof (when the thoracic vertebra is curved, near the apex of the curve) are pressed from both sides in the left-right direction by the pair of chest pressing bodies 31 via the chest-lateral support pads 42. In this case, as illustrated in FIG. 14(a), for example, when the head section is positioned on the right side in the figure than the reference vertical line CL (see FIG. 14(b)) from the center in the left-right direction of the pelvis of the patient, the movement amounts of the pair of chest pressing bodies 31 are adjusted such that the movement amount of the chest pressing body 31 on the right side in the figure is larger than that of the chest pressing body 31 on the left side in the figure so that the head section is positioned on the vertical line CL from the pelvis.

Subsequently, at that position, the switch portions 71 of the chest presser fixing means 33 are slid (by one-touch operation) in the lock direction (the direction toward the head section) whereby the pair of chest pressing bodies 31 are fixed to the chest support 32. In this case, in the pair of chest pressing bodies 31, the chest pressing bodies 31 may be moved in the direction closer to each other substantially at the same time and be fixed to the chest support 32. Alternatively, in the pair of chest pressing bodies 31, after one chest pressing body 31 is fixed in advance to an arbitrary position in relation to the chest support 32, and the other chest pressing body 31 may be moved closer to the one chest pressing body 31 so as to be fixed to the chest support 32.

As a result, as understood from FIG. 14(b), the trunk balance in the left-right direction of the patient is achieved, the position in the left-right direction of the entire spine is corrected (that is, the position in the left-right direction of the entire spine is corrected) so that the head section is positioned on the vertical line CL of the spine from the center in the left-right direction of the pelvis (that is, the head section is positioned on an extension line connecting the spinous process of the seventh cervical vertebra and the spinous process of the first sacral vertebra)), and that state can be maintained. Particularly, in adult scoliosis, the trunk balance in the left-right direction of patients is often disturbed, and correction of this trunk balance is an important factor.

In the present embodiment, after the waist and the vicinity of the patient are pressed from both sides in the left-right direction by the pair of waist pressing bodies 160, the chest of the patient and the vicinity thereof are pressed from both sides in the left-right direction by the pair of chest pressing bodies 31, which is the best form. However, after the chest of the patient and the vicinity thereof are pressed from both sides in the left-right direction by the pair of chest pressing bodies 31, the waist of the patient and the vicinity thereof may be pressed from both sides in the left-right direction by the pair of waist pressing bodies 160. However, there is no particular limitation to this order.

Subsequently, also referring to FIGS. 1 and 2, the switch portions 124 of the pair of waist pressing unit fixation device 170 are slid (by one-touch operation) in the unlock direction (the direction toward the head section) so that the waist pressing unit 6 can move along the pair of rail members 14. Moreover, the switch portions 124 of the pair of chest pressing unit fixing means 96 are slid (by one-touch operation) in the unlock direction (the direction toward the legs) so that the chest pressing unit 5 can move along the pair of rail members 14.

Subsequently, as illustrated in FIG. 14(c), from the state of FIG. 14(b), the operator pulls (tows) the trunk of the patient in the cranio-caudal direction while grasping both upper limbs and both lower limbs of the patient. As a result, the pair of chest pressing bodies 31 of the chest pressing unit 5 and the pair of waist pressing bodies 160 of the waist pressing unit 6 move along the pair of rail members 14 so as to move away from each other according to the stretching of the body of the patient. Substantially at the same time as this, as illustrated in FIG. 14(d), the operator further moves the waist pressing unit 6 toward the caudal side along the pair of rail members 14 and further moves the waist of the patient and the vicinity thereof integrally toward the caudal side. Moreover, the operator further moves the chest pressing unit 5 toward the cranial side along the pair of rail members 14 so as to be separated from the waist pressing unit 6 and further moves the chest of the patient and the vicinity thereof integrally toward the cranial side. In this case, since the chest pressing unit 5 is integrally connected to the head support unit 7, the head support unit 7 can move toward the cranial side according to the movement of the chest pressing unit 5 toward the cranial side, and the head section of the patient can be moved toward the cranial side without any problem.

In this case, due to the non-slip projections 166 connected to the pair of waist pressing bodies 160, the waist of the patient and the vicinity thereof can be moved toward the caudal side integrally with the pair of waist pressing bodies 160 while preventing the pair of waist pressing bodies 160 from sliding from both side surfaces in the left-right direction of the waist of the patient. Moreover, due to the non-slip projections 37 connected to the pair of chest pressing bodies 31, the chest of the patient and the vicinity thereof can be moved toward the cranial side integrally with the pair of chest pressing bodies 31 while preventing the pair of chest 31 from sliding from both side surfaces in the left-right direction of the chest of the patient.

Subsequently, after the waist pressing unit 6 and the chest pressing unit 5 are moved along the pair of rail members 14, in the state of FIG. 14(e), the switch portions 124 of the pair of waist pressing unit fixation device 170 are slid (by one-touch operation) in the lock direction (the direction toward the legs) so that the waist pressing unit 6 is fixed to the pair of rail members 14 and the waist of the patient and the vicinity thereof are positioned in the cranio-caudal direction. Substantially at the same time as this, the switch portions 124 of the pair of chest pressing unit fixing means 96 are slid (by one-touch operation) in the lock direction (the direction toward the head section) so that the chest pressing unit 5 is fixed to the pair of rail members 14 and the waist of the patient and the vicinity thereof are positioned in the cranio-caudal direction.

By the operator performing the operation of towing the patient in the cranio-caudal direction and the operation of separating the chest pressing unit 5 and the waist pressing unit 6 from each other, the chest of the patient and the vicinity thereof and the waist of the patient and the vicinity thereof are pulled in the cranio-caudal direction whereby a tensile load can be applied to a deformed spine in the cranio-caudal direction and that state can be maintained. By this operation, the spinal deformities of the patient (that is, a scoliosis, a kyphosis, and a lordosis) can be corrected in advance so as to approach a correction rate by the surgical spinal deformity correction and fusion surgery, and that state can be maintained. Moreover, since the components of the supporting device 1 are formed of a material that transmits X-rays, the degree of correction corrected in advance by the supporting device 1 can be confirmed by an X-ray photograph or a 3D scan image by an X-ray fluoroscopy apparatus or a multi-axis CT-like image creation apparatus (not illustrated).

After the correction state of the spinal deformities is confirmed by an X-ray photograph or a 3D scan image by an X-ray fluoroscopy apparatus or a multi-axis CT-like image creation apparatus (not illustrated), when further correction is required, the above-described operation of pressing the chest from both sides in the left-right direction by the pair of chest pressing bodies 31, the operation of pressing the waist from both sides in the left-right direction by the pair of waist pressing bodies 160, and the operation of separating the chest pressing unit 5 and the waist pressing unit 6 are further performed.

Subsequently, in a state in which the spinal deformities are corrected in advance by the supporting device 1 and is maintained as illustrated in FIG. 14(e), an operator performs surgical spinal deformity correction and fusion surgery (that is, “posterior correction and fusion surgery” (see FIG. 18) on the spinal deformity as illustrated in FIG. 14(f).

The spinal deformities of the patient are corrected in advance by the supporting device 1 as much as possible (that is, an effective correction rate is achieved) and is maintained. Therefore, when the operator performs surgical spinal deformity correction and fusion surgery, it is possible to simplify (facilitate) the operative procedures for correcting the spinal deformities three-dimensionally including twisting, such as the operation of attaching the rod 230 to the screws 210 and the hook members 220, the operation of applying a compressive load or a tensile load to the screws 210 and the hook members 220 in the cranio-caudal direction, and the operation of rotating the rod 230 as illustrated in FIGS. 14(f) and 18. Moreover, it is possible to shorten the operative time remarkably and lessen the burden on the patient. Furthermore, by the surgical spinal deformity correction and fusion surgery illustrated in FIG. 14(f), a more effective correction rate can be achieved for the spinal deformities by implants such as the rod 230, the screws 210, and the hook members 220.

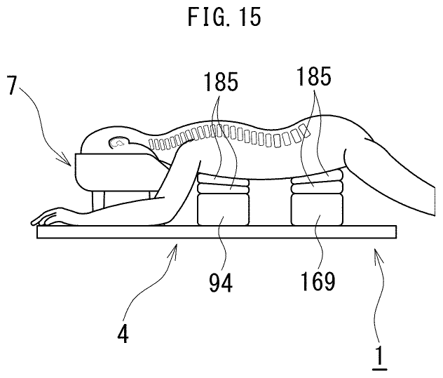

However, when the supporting device 1 is used, as illustrated in FIG. 15, a plurality of cushion members 185 may be overlaid as necessary on the upper surfaces of the chest-front support pads 94 and the waist-front support pads 169 and the height of a range of region extending from the chest of the patient to the waist may be adjusted so as to correspond to the kyphosis of the patient. In this way, as understood from FIG. 15, when a patient with a scoliosis, a kyphoscoliosis, or a kyphosis is positioned on the upper surface of the cushion member 185 in a prone position, the kyphosis is naturally corrected and a lateral balance can be improved.

The supporting device 1 may be operated during the surgical spinal deformity correction and fusion surgery. For example, during the surgical spinal deformity correction and fusion surgery, by operating the pair of chest pressing unit fixing means 96 or the pair of waist pressing unit fixation device 170, the chest pressing unit 5 or the waist pressing unit 6 may be moved further toward the cranial side or the caudal side and the tensile load may be applied to the spine in the cranio-caudal direction. Moreover, during the spinal deformity correction and fusion surgery, by operating the chest presser fixing means 33 and the waist pressing body fixation device 162, the chest and the vicinity thereof may be further pressed from both sides in the left-right direction by the pair of chest pressing bodies 31 and the waist and the vicinity thereof may be further pressed from both sides in the left-right direction by the pair of waist pressing bodies 160. In this way, the trunk balance may be further corrected.

When the spinal deformities are corrected by such a supporting device 1, it is necessary to perform the correction while confirming that no failure has occurred in the spinal nerve using the somatosensory evoked potential (SEP) and the motor evoked potential (MEP).

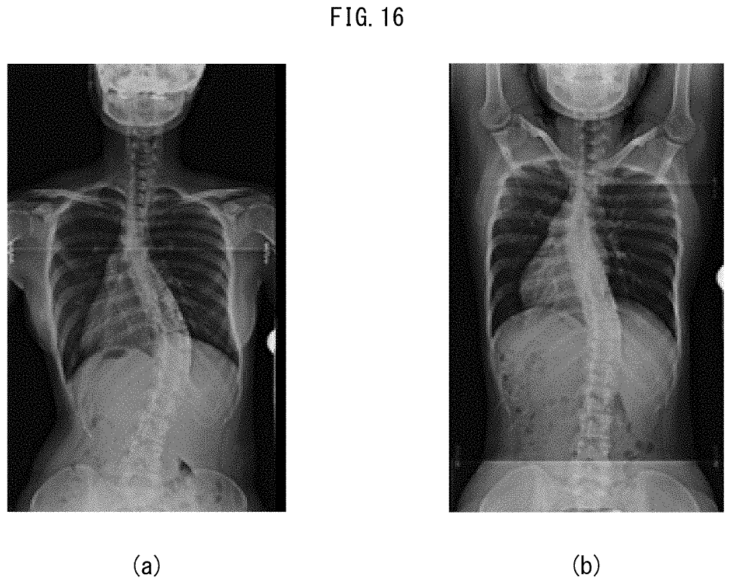

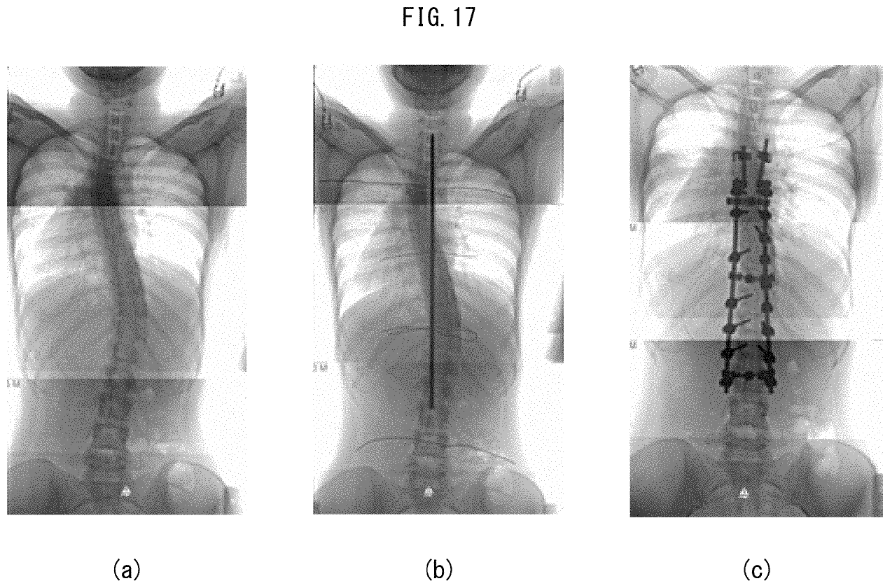

Next, the correction effect of spinal deformity by the supporting device 1 will be described in detail on the basis of FIGS. 16 and 17.

FIG. 16(a) is a frontal X-ray photograph in a standing position of a scoliosis patient before surgery. Referring to this photograph, this scoliosis is a case of a single curve in the Thoracic-lumbar junction, and the Cobb angle is approximately 43 degrees. Moreover, the trunk balance in the left-right direction is slightly disturbed (that is, the head section is slightly shifted to the right side of the figure from the vertical line from the center in the left-right direction of the pelvis. FIG. 16(b) is a frontal X-ray photograph of the patient illustrated in FIG. 16(a) in a state in which the patient before surgery is pulled in the cranio-caudal direction. Referring to this photograph, it is understood that the Cobb angle is approximately 20 degrees, and the spinal deformity is improved as compared with the state of FIG. 16(a).

FIG. 17(a) is an X-ray photograph in a prone position of the patient illustrated in FIG. 16 in a state in which the patient is placed on the supporting device 1, the chest and the vicinity thereof are pressed from both sides in the left-right direction by the pair of chest pressing bodies 31 of the chest pressing unit 5, and the waist and the vicinity thereof are pressed from both sides in the left-right direction by the pair of waist pressing bodies 160 of the waist pressing unit 6. Referring to this photograph, it is understood that the head section is positioned on the vertical line from the center in the left-right direction of the pelvis, and the trunk balance is normally improved. Moreover, it is understood that the Cobb angle is approximately 21 degrees, and the spinal deformity is improved (the correction rate of approximately 51%) as compared with the state of FIG. 16(a).

FIG. 17(b) is an X-ray photograph in a prone position in a state in which from the state of FIG. 17(a), while both upper limbs and both lower limbs of the patient are pulled in the cranio-caudal direction and the trunk is pulled in the cranio-caudal direction, the pair of chest pressing bodies 31 (the chest pressing unit 5) and the pair of waist pressing bodies 160 (the waist pressing unit 6) are separated from each other, whereby a tensile load is applied to the spinal deformities in the cranio-caudal direction. Referring to this photograph, it is understood that the Cobb angle is approximately 15 degrees, and the spinal deformity is improved remarkably (the correction rate of approximately 65%) from the state of FIG. 16(a) (the Cobb angle of) 45°. FIG. 17(c) is an X-ray photograph in a prone position after surgical spinal deformity correction and fusion surgery (that is, “posterior correction and fusion surgery”) is performed on the patient on the supporting device 1. Referring to this photograph, it is understood that the trunk balance is normally improved, the Cobb angle disappears, and the spinal deformity is improved with a correction rate of 90% or higher.

According to the data of fifty two cases extracted randomly among the cases of performing spinal deformity correction and fusion surgery (posterior correction and fusion surgery) using the supporting device 1, it is understood that the average Cobb angle of spinal deformities in a standing position before surgery was 40.3 (±13.1) degrees and the average Cobb angle during towing (when X-ray photography was performed in a state in which the patient was towed in the cranio-caudal direction before surgery) was 26.1 (±10.6) degrees. In contrast, it is understood that the average Cobb angle after using the supporting device 1 was 18.7 (±8.8) degrees, and the spinal deformity was improved remarkably when the supporting device 1 was used. Moreover, it is understood that the average loss of the trunk balance in a standing position before surgery was 39.8 (±27.1) mm, whereas the average loss of the trunk balance after using the supporting device 1 was 1.6 (±5.6) mm, and the trunk balance was improved remarkably when the supporting device 1 was used.

From these results, it is understood that the supporting device 1 is effective for correction of spinal deformity and the trunk balance.

As described above, in the supporting device 1 according to the present embodiment, by pressing the waist of the patient and the vicinity thereof from both sides in the left-right direction by the pair of waist pressing bodies 160 and pressing the chest of the patient and the vicinity thereof from both sides in the left-right direction by the pair of chest pressing bodies 31, it is possible to achieve the trunk balance in the left-right direction of the patient and correct and maintain the position in the left-right direction of the entire spine. Moreover, in this state, by separating the pair of chest pressing bodies 31 and the pair of waist pressing bodies 160 while pulling the body of the patient in the cranio-caudal direction, it is possible to apply a tensile load to the spinal deformities in the cranio-caudal direction to correct and maintain the spinal deformity (that is, a scoliosis, a kyphosis, and a lordosis). As a result, it is possible to maintain the spinal deformity in the state in which the spinal deformity is corrected in advance so as to approach a correction rate by the surgical spinal deformity correction and fusion surgery.

Since the surgical spinal deformity correction and fusion surgery of the operator is performed in a state in which the spinal deformities are corrected by the supporting device 1 as much as possible, it is possible to simplify the operative procedures for correcting the spinal deformities three-dimensionally including twisting, shorten the operative time remarkably, and lessen the burden on the patient. Furthermore, due to this surgical spinal deformity correction and fusion surgery, it is possible to achieve an effective correction rate by surgical spinal deformity correction and fusion surgery (using implants).

Since the components of the supporting device 1 according to the present embodiment are formed of a material that transmits X-rays, it is possible to confirm the degree of correction of spinal deformities and an attachment state of implants such as the screwing state of the screws 210 and the attachment state of the hook members 220 with the aid of a CT apparatus (for example, a multi-axis CT-like image creation apparatus) at an appropriate timing including during the spinal deformity correction and fusion surgery. In the surgical spinal deformity correction and fusion surgery (posterior correction and fusion surgery) for spinal deformities in which the supporting device 1 is used, a multi-axis CT-like image creation apparatus is used at an appropriate timing such as immediately before starting surgery, during surgery, or immediately after starting surgery. The multi-axis CT-like image creation apparatus photographs the patient multilaterally with an arm having eight axes rotating to obtain 3D scan images in only several seconds. Due to this, the use of a material capable of transmitting X-rays as a material for the components of the supporting device 1 is particularly important and effective in improving the correction rate by the spinal deformity correction and fusion surgery, the correction effect, and the safety of the spinal deformity correction and fusion surgery.

Since the supporting device 1 according to the present embodiment includes the clamp member 27 as a connection means detachably connected to the operating table 10, when an external input is applied to the patient from the operator during spinal deformity correction and fusion surgery (that is, during the operation of screwing the screws 20 or the operation of rotating the rod 230), it is possible to suppress movement of the supporting device 1 in relation to the operating table 10, and the correction rate by the spinal deformity correction and fusion surgery, the correction effect, and the safety of the spinal deformity correction and fusion surgery are improved. Furthermore, the supporting device 1 can follow the movement of the operating table 10 during the spinal deformity correction and fusion surgery.

In the supporting device 1 according to the present embodiment, the pair of chest pressing bodies 31 are detachably attached to the chest support 32, and the pair of waist pressing bodies 160 are also detachably attached to the waist support 161. Due to this, when the patient is to be placed on the supporting device 1, the pair of chest pressing bodies 31 can be detached from the chest support 32, and the pair of waist pressing bodies 160 can be detached from the waist support 161. Therefore, the patient can be easily transferred onto the supporting device 1.

The supporting device 1 according to the present embodiment includes the chest presser fixing means 33 that fixes the chest pressing body 31 at an arbitrary position or releases the same so as to be movable in response to the slide operation of the switch portion 71 by the operator, the waist pressing body fixation device 162 that fixes the waist pressing body 160 at an arbitrary position or releases the same so as to be movable in response to the slide operation of the switch portion 71 by the operator, the chest pressing unit fixing means 96 that fixes the chest pressing unit 5 at an arbitrary position in the cranio-caudal direction or releases the same so as to be movable in response to the slide operation of the switch portion 124 by the operator, and the waist pressing unit fixation device 170 that fixes the waist pressing unit 6 at an arbitrary position in the cranio-caudal direction or releases the same so as to be movable in response to the slide operation of the switch portion 124 by the operator.

As a result, the operability of the supporting device 1 is improved remarkably. In other words, since the supporting device 1 can be operated by the slide operation (one-touch operation) of the switch portions 71 and 124, the supporting device 1 can be operated easily in a special (clean) area on an operating table in an operating room. Furthermore, during the spinal deformity correction and fusion surgery, by operating the chest pressing unit fixing means 96 and the waist pressing unit fixation device 170, a tensile load can be easily applied to the spinal deformity from the outside (the outer surface of the patient). Moreover, during the spinal deformity correction and fusion surgery, by operating the chest presser fixing means 33 and the waist pressing body fixation device 162, the chest and the vicinity thereof and the waist and the vicinity thereof can be pressed from both sides in the left-right direction, and the trunk balance can be effectively corrected further.

Since the supporting device 1 according to the present embodiment includes the head support 136 that supports the head section of the patient at a predetermined height, the head section of the patient can be easily supported and protected during the spinal deformity correction and fusion surgery. Moreover, since the head support 136 includes the cushion portion 153, the burden on the face can be minimized during the spinal deformity correction and fusion surgery, and stable positioning is possible. Furthermore, since the head support 136 is integrally connected to the pair of chest pressing bodies 31 of the chest pressing unit 5, when the chest pressing unit 5 is moved in the cranio-caudal direction of the patient, the head support 136 is also moved. Therefore, the head section of the patient can be protected by the head support 136 without any problem during and after the movement.

In the supporting device 1 according to the present embodiment, since the openings 155 are formed in portions of the head support 136 corresponding to the eyes and the mouth of the patient, the pressure on the eyes or the like of the patient during the spinal deformity correction and fusion surgery can be suppressed, and an intubation tube 175 extending from the mouth of the patient can be easily extended from the openings 155 to the outside. Moreover, since the mirror member 148 is disposed between the head supporting plate 138 and the head support 136 of the head support unit 7, the condition of the face and the eyes of the patient, the presence of pressure on the airway, and the condition of the intubation tube 175 can be visually recognized by the mirror member 148.

The supporting device 1 according to the present embodiment is fixed to the top plate 11 of the operating table 10 that is movable and likable according to the operation during photographing of the multi-axis CT-like image creation apparatus. The supporting device 1 is used in an operating room in which a navigation apparatus (not illustrated) capable of performing spinal deformity correction and fusion surgery while monitoring the condition of a lesion and the position of surgical instruments in real-time is disposed in addition the multi-axis CT-like image creation apparatus and the operating table 10. As described above, the supporting device 1 can maintain a state in which the spinal deformities of the patient are corrected in advance so as to approach the correction rate by surgical spinal deformity correction and fusion surgery and can provide the following effects as other effects. That is, since the supporting device 1 can tightly maintain the patient at a predetermined posture during surgery, the positional accuracy of the screwing position of the screws 210 (see FIG. 18) into the vertebral body can be improved by the navigation apparatus (which performs navigation surgery on the basis of the image of the patient photographed during or immediately before the surgery). As a result, it is possible to enhance the safety of surgery and lessen the burden on the patient (such as shortening of the operative time).

In the supporting device 1 according to the present embodiment, the operator manually performs the operation of pressing the waist of the patient and the vicinity thereof from both sides in the left-right direction using the pair of waist pressing bodies 160, the operation of pressing the chest of the patient and the vicinity thereof from both sides in the left-right direction using the pair of chest pressing bodies 31, and the operation of moving the chest pressing unit 5 and the waist pressing unit 6 in the direction away from each other. However, the pair of waist pressing bodies 160 may be moved in the direction closer to each other to press the waist of the patient and the vicinity thereof from both sides in the left-right direction by driving a waist presser motor, and the pair of chest pressing bodies 31 may be moved in the direction closer to each other to press the chest of the patient and the vicinity thereof from both sides in the left-right direction by driving a chest presser motor. Furthermore, the chest pressing unit 5 and the waist pressing unit 6 may be moved in the direction away from each other by driving a chest unit motor and a waist unit motor. In this way, since the operator only needs to operate the switch to drive or stop the motors, the labor of the operator can be reduced.

A waist pressure sensor may be provided on the surfaces of the pair of waist-lateral support pads 167, and the pressure applied from the pair of waist-lateral support pads 167 to the waist of the patient and the vicinity thereof may be measured by the waist pressure sensors. Similarly, a chest pressure sensor may be provided on the surfaces of the pair of chest-lateral support pads 42, and the pressure applied from the pair of chest-lateral support pads 42 to the chest of the patient and the vicinity thereof may be measured by the chest pressure sensors. The detection contents from the waist pressure sensors and the chest pressure sensors are transmitted to a controller. The controller is electrically connected to the waist presser motor, the chest presser motor, the chest unit motor, and the waist unit motor. The controller may control the driving of the waist presser motor, the chest presser motor, the chest unit motor, and the waist unit motor on the basis of the detection contents from the waist pressure sensors and the chest pressure sensors. In this way, the labor of the operator can be reduced further.

### REFERENCE SIGNS LIST

1: Spinal deformity correction and fusion surgery supporting device

5: Chest pressing unit

6: Waist pressing unit

10: Operating table

11: Top plate

27: Clamp member (Coupler)

31: Chest pressing body

32: Chest support

33: Chest presser fixing means

52: Switch member (Slide switch)

71: Switch portion

96: Chest pressing unit fixing means (Fixing means)

100: Switch member (Slide switch)

124: Switch portion

136: Head support

152: Head supporting section

153: Cushion portion

155: Opening

160: Waist pressing body

161: Waist support

162: Waist pressing body fixation device

170: Waist pressing unit fixation device (Fixing means)

1. A spinal deformity correction and fusion surgery supporting device, which is placed on an operating table in an operating room, wherein:
the supporting device is structured to:
correct a spinal deformity of a patient and to hold the patient in the corrected state so as to facilitate spinal deformity correction and fusion surgery;
apply to the spinal deformity of the patient under general anesthesia who wears a mask or undergoes endotracheal intubation; and
apply immediately before or during the surgery, the supporting device comprising:
a pair of chest pressing bodies each of which is structured to be shiftable so as to draw near to and separate from each other in a crosswise direction orthogonal to a cranio-caudal direction of the patient, the chest pressing bodies being structured to be fixable in an arbitrary position;
a pair of waist pressing bodies each of which is structured to be shiftable so as to draw near to and separate from each other in a crosswise direction orthogonal to a cranio-caudal direction of the patient, the waist pressing bodies being structured to be fixable in an arbitrary position; and
a fixation device that is structured in that the pair of chest pressing bodies and the pair of waist pressing bodies are shiftable so as to draw near to and separate from each other in a cranio-caudal direction of the patient, the fixation device being structured to fix the chest pressing bodies and the waist pressing bodies in an arbitrary position,
wherein the pair of waist pressing bodies are structured to press a waist portion and the surrounding area of the patient from both the left and right sides, and the pair of chest pressing bodies are structured to press a chest portion and the surrounding area of the patient from both the left and right sides, and while keeping the tightened state, the pair of chest pressing bodies and the pair of waist pressing bodies are structured to separate from each other so as to apply a tensile load relative to the deformed spine of the patient in a cranio-caudal direction, and
wherein the supporting device is structured to correct the spine of the patient so as to approach to obtain a correction rate achievable by the surgery, the supporting device enabling the patient to be held in the corrected state.

2. The spinal deformity correction and fusion surgery supporting device according to claim 1, wherein each structural member of the supporting device is composed of materials, which are X-ray permeable.

3. The spinal deformity correction and fusion surgery supporting device according to claim 1 further including a coupler in which to detachably couple the supporting device with the operating table.

4. The spinal deformity correction and fusion surgery supporting device according to claim 1, wherein:
each of the pair of chest pressing bodies is detachably mounted to a chest support that extends in a crosswise direction orthogonal to the cranio-caudal direction of the patient, and
each of the pair of waist pressing bodies is detachably mounted to a waist support that extends in a crosswise direction orthogonal to the cranio-caudal direction of the patient.

5. The spinal deformity correction and fusion surgery supporting device according to claim 1, wherein the supporting device is specialized for posterior correction and fusion surgery in the spinal deformity correction and fusion surgery.

6. The spinal deformity correction and fusion surgery supporting device according to claim 1, further including:
a chest pressing body fixation device that enables the chest pressing bodies to fix in an arbitrary position or be released for shift, through operation of a slide switch by an operator;
a waist pressing body fixation device that enables the waist pressing bodies to fix in an arbitrary position or be released for shift, through operation of a slide switch by the operator;
a chest pressing unit fixation device that enables a chest pressing unit, which includes the pair of chest pressing bodies, to fix in an arbitrary position in a cranio-caudal direction of the patient or be released for shift, through operation of a slide switch by the operator; and
a waist pressing unit fixation device that enables a waist pressing unit, which includes the pair of waist pressing bodies, to fix in an arbitrary position in a cranio-caudal direction of the patient or be released for shift, through operation of a slide switch by the operator.

7. The spinal deformity correction and fusion surgery supporting device according to claim 1, further including:
a head support that is structured to support the head of the patient at a prescribed height and couple with the pair of chest pressing bodies, wherein the head support includes:
a head supporting section with a concaved section, the concaved section being structured to support and enfold the face of the patient; and
a cushion portion arranged in the concaved section of the head supporting section.

8. The spinal deformity correction and fusion surgery supporting device according to claim 7, wherein the head support includes an opening at each place where the patient's eyes and mouth are positioned.

9. The spinal deformity correction and fusion surgery supporting device according to claim 2 further including a coupler in which to detachably couple the supporting device with the operating table.

10. The spinal deformity correction and fusion surgery supporting device according to claim 2, wherein:
each of the pair of chest pressing bodies is detachably mounted to a chest support that extends in a crosswise direction orthogonal to the cranio-caudal direction of the patient, and
each of the pair of waist pressing bodies is detachably mounted to a waist support that extends in a crosswise direction orthogonal to the cranio-caudal direction of the patient.

11. The spinal deformity correction and fusion surgery supporting device according to claim 3, wherein:
each of the pair of chest pressing bodies is detachably mounted to a chest support that extends in a crosswise direction orthogonal to the cranio-caudal direction of the patient, and
each of the pair of waist pressing bodies is detachably mounted to a waist support that extends in a crosswise direction orthogonal to the cranio-caudal direction of the patient.

12. The spinal deformity correction and fusion surgery supporting device according to claim 2, wherein the supporting device is specialized for posterior correction and fusion surgery in the spinal deformity correction and fusion surgery.

13. The spinal deformity correction and fusion surgery supporting device according to claim 3, wherein the supporting device is specialized for posterior correction and fusion surgery in the spinal deformity correction and fusion surgery.

14. The spinal deformity correction and fusion surgery supporting device according to claim 4, wherein the supporting device is specialized for posterior correction and fusion surgery in the spinal deformity correction and fusion surgery.

15. The spinal deformity correction and fusion surgery supporting device according to claim 2, further including:
a chest pressing body fixation device that enables the chest pressing bodies to fix in an arbitrary position or be released for shift, through operation of a slide switch by an operator;
a waist pressing body fixation device that enables the waist pressing bodies to fix in an arbitrary position or be released for shift, through operation of a slide switch by the operator;
a chest pressing unit fixation device that enables a chest pressing unit, which includes the pair of chest pressing bodies, to fix in an arbitrary position in a cranio-caudal direction of the patient or be released for shift, through operation of a slide switch by the operator; and
a waist pressing unit fixation device that enables a waist pressing unit, which includes the pair of waist pressing bodies, to fix in an arbitrary position in a cranio-caudal direction of the patient or be released for shift, through operation of a slide switch by the operator.

16. The spinal deformity correction and fusion surgery supporting device according to claim 3, further including:
a chest pressing body fixation device that enables the chest pressing bodies to fix in an arbitrary position or be released for shift, through operation of a slide switch by an operator;
a waist pressing body fixation device that enables the waist pressing bodies to fix in an arbitrary position or be released for shift, through operation of a slide switch by the operator;
a chest pressing unit fixation device that enables a chest pressing unit, which includes the pair of chest pressing bodies, to fix in an arbitrary position in a cranio-caudal direction of the patient or be released for shift, through operation of a slide switch by the operator; and
a waist pressing unit fixation device that enables a waist pressing unit, which includes the pair of waist pressing bodies, to fix in an arbitrary position in a cranio-caudal direction of the patient or be released for shift, through operation of a slide switch by the operator.

17. The spinal deformity correction and fusion surgery supporting device according to claim 4, further including:
a chest pressing body fixation device that enables the chest pressing bodies to fix in an arbitrary position or be released for shift, through operation of a slide switch by an operator;
a waist pressing body fixation device that enables the waist pressing bodies to fix in an arbitrary position or be released for shift, through operation of a slide switch by the operator;
a chest pressing unit fixation device that enables a chest pressing unit, which includes the pair of chest pressing bodies, to fix in an arbitrary position in a cranio-caudal direction of the patient or be released for shift, through operation of a slide switch by the operator; and
a waist pressing unit fixation device that enables a waist pressing unit, which includes the pair of waist pressing bodies, to fix in an arbitrary position in a cranio-caudal direction of the patient or be released for shift, through operation of a slide switch by the operator.

18. The spinal deformity correction and fusion surgery supporting device according to claim 5, further including:
a chest pressing body fixation device that enables the chest pressing bodies to fix in an arbitrary position or be released for shift, through operation of a slide switch by an operator;
a waist pressing body fixation device that enables the waist pressing bodies to fix in an arbitrary position or be released for shift, through operation of a slide switch by the operator;
a chest pressing unit fixation device that enables a chest pressing unit, which includes the pair of chest pressing bodies, to fix in an arbitrary position in a cranio-caudal direction of the patient or be released for shift, through operation of a slide switch by the operator; and
a waist pressing unit fixation device that enables a waist pressing unit, which includes the pair of waist pressing bodies, to fix in an arbitrary position in a cranio-caudal direction of the patient or be released for shift, through operation of a slide switch by the operator.

19. The spinal deformity correction and fusion surgery supporting device according to claim 2, further including:
a head support that is structured to support the head of the patient at a prescribed height and couple with the pair of chest pressing bodies, wherein the head support includes:
a head supporting section with a concaved section, the concaved section being structured to support and enfold the face of the patient; and
a cushion portion arranged in the concaved section of the head supporting section.

20. The spinal deformity correction and fusion surgery supporting device according to claim 3, further including:
a head support that is structured to support the head of the patient at a prescribed height and couple with the pair of chest pressing bodies, wherein the head support includes:
a head supporting section with a concaved section, the concaved section being structured to support and enfold the face of the patient; and
a cushion portion arranged in the concaved section of the head supporting section.
